(19) United States
(12) Patent Application Publication
(10) Pub. No.: US 2023/0407050 A1
(43) Pub. Date: Dec. 21, 2023

(54) METHOD FOR STABILIZING AN ORGANIC MATERIAL USING A STABILIZER MIXTURE

(71) Applicant: BASF SE, Ludwigshafen am Rhein (DE)

(72) Inventors: Tania WEYLAND, Kaisten (CH); Heinz HERBST, Kaisten (CH); Manuele VITALI, Pontecchio Marconi BO (IT); Daniel MUELLER, Kaisten (CH)

(73) Assignee: BASF SE, Ludwigshafen am Rhein (DE)

(21) Appl. No.: 18/035,176

(22) PCT Filed: Oct. 28, 2021
(86) PCT No.: PCT/EP2021/079940

§ 371 Date: May 3, 2023

(30) Foreign Application Priority Data
Nov. 3, 2020 (EP) 20205384.9

(51) Int. Cl. C08K 5/3492; C08K 3/26; C08K 3/22; C08K 5/3475

(52) U.S. Cl. CPC C08K 5/3492; C08K 3/26; C08K 3/22; C08K 5/3475; C08K 2003/267; C08K 2003/2224

(57) ABSTRACT

The presently claimed invention relates to a method for stabilizing an organic material by reducing degradation induced by a chlorine containing compound. The presently claimed invention further relates to a stabilizer mixture comprising at least one compound (A), at least one UV absorber, and at least one metal hydroxide. The presently claimed invention also relates to a composition comprising an organic material, and the stabilizer mixture. Further, the presently claimed invention relates to an article prepared from the composition. Still further, the presently claimed invention relates to a use of the stabilizer mixture for stabilizing an organic material by reducing degradation induced by a chlorine containing compound.

### FIELD OF THE INVENTION

The presently claimed invention relates to a method for stabilizing an organic material by reducing degradation induced by a chlorine containing compound. The presently claimed invention further relates to a stabilizer mixture comprising at least one compound (A), at least one UV absorber, and at least one metal hydroxide. The presently claimed invention also relates to a composition comprising an organic material, and the stabilizer mixture. Further, the presently claimed invention relates to an article prepared from the said composition. Still further, the presently claimed invention relates to a use of the stabilizer mixture for stabilizing an organic material by reducing degradation induced by a chlorine containing compound.

### BACKGROUND OF THE INVENTION

Organic materials namely synthetic polymers such as polyolefins, polyethylenes, and the like are used in wide variety of applications due to their ease of use in the manufacturing of a variety of extruded and moulded articles. Exemplary articles such as greenhouse, mulch film or tapes are prepared using the organic material. However, these articles frequently suffer from general stability due to repeated exposure to the UV light. Sterically hindered amines are known in the art to be efficient stabilizers, preventing the ill effects of UV light on the articles prepared from the organic material. However, these articles when exposed to high level of chlorine containing agrochemicals or bleaching agents are subjected to enhanced degradation which subsequently leads to loss of tensile strength. The major cost factor of greenhouses or artificial turf is the installation. The loss of tensile strength leads to premature damage of greenhouses or artificial turf, causing a lot of effort as well as cost for the replacement.

Thus, it is an object of the present invention to provide a multilayer film with a high stability by reducing the degradation induced by a high level of chlorine containing compounds.

### SUMMARY OF THE INVENTION

Surprisingly, it has been found that the multilayer film prepared in accordance with a method of the presently claimed invention using a certain stabilizer mixtures exhibits a substantial improvement of the elongation at break property and therefore stabilizes the multilayer film by reducing degradation induced by the high level of chlorine containing compounds. Thus, in one aspect, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

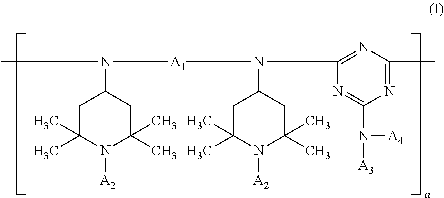

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂ cycloalkyloxy,
A₃ and A₄ are independently selected from H, linear or branched, substituted or unsubstituted C₁-C₁₂ alkyl, substituted or unsubstituted C₅-C₁₂cycloalkyl and a group of the formula (a-1),

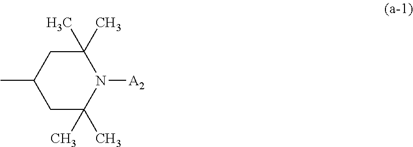

or
A₃ and A₄, together with the nitrogen atom to which they are bonded, form a 5- to 10-membered heterocyclic ring; and
a is an integer in the range of 1 to 20 and the repeating units are the same or different,
compound (A) of general formula (II)

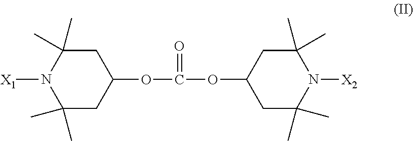

wherein
x₁ and x₂ are independently selected from linear or branched, substituted or unsubstituted C₁ to C₃₀ alkyloxy,
compound (A) of general formula (III)

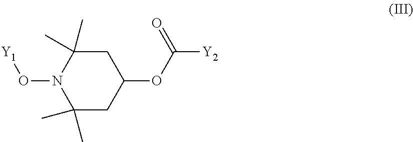

wherein
Y₁ is linear or branched, substituted or unsubstituted C₃ to C₂₀ alkyl,
Y₂ is linear or branched, substituted or unsubstituted C₁ to C₃₀ alkyl; and
compound (A) of general formula (IV)

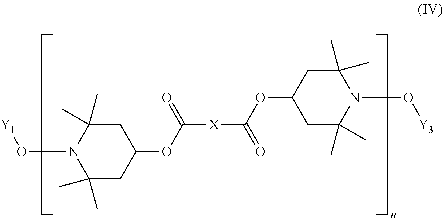

wherein
Y₁ is linear or branched, substituted or unsubstituted C₃ to C₂₀ alkyl,
Y₃ is selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber; and
(iii) at least one metal hydroxide.

In another aspect, the presently claimed invention is directed to a stabilizer mixture comprising:
(i) at least one compound (A) selected from the general formula (A-1), general formula (A-2), general formula (A-4), general formula (A-5), general formula (A-6), general formula (A-7), and general formula (A-8)

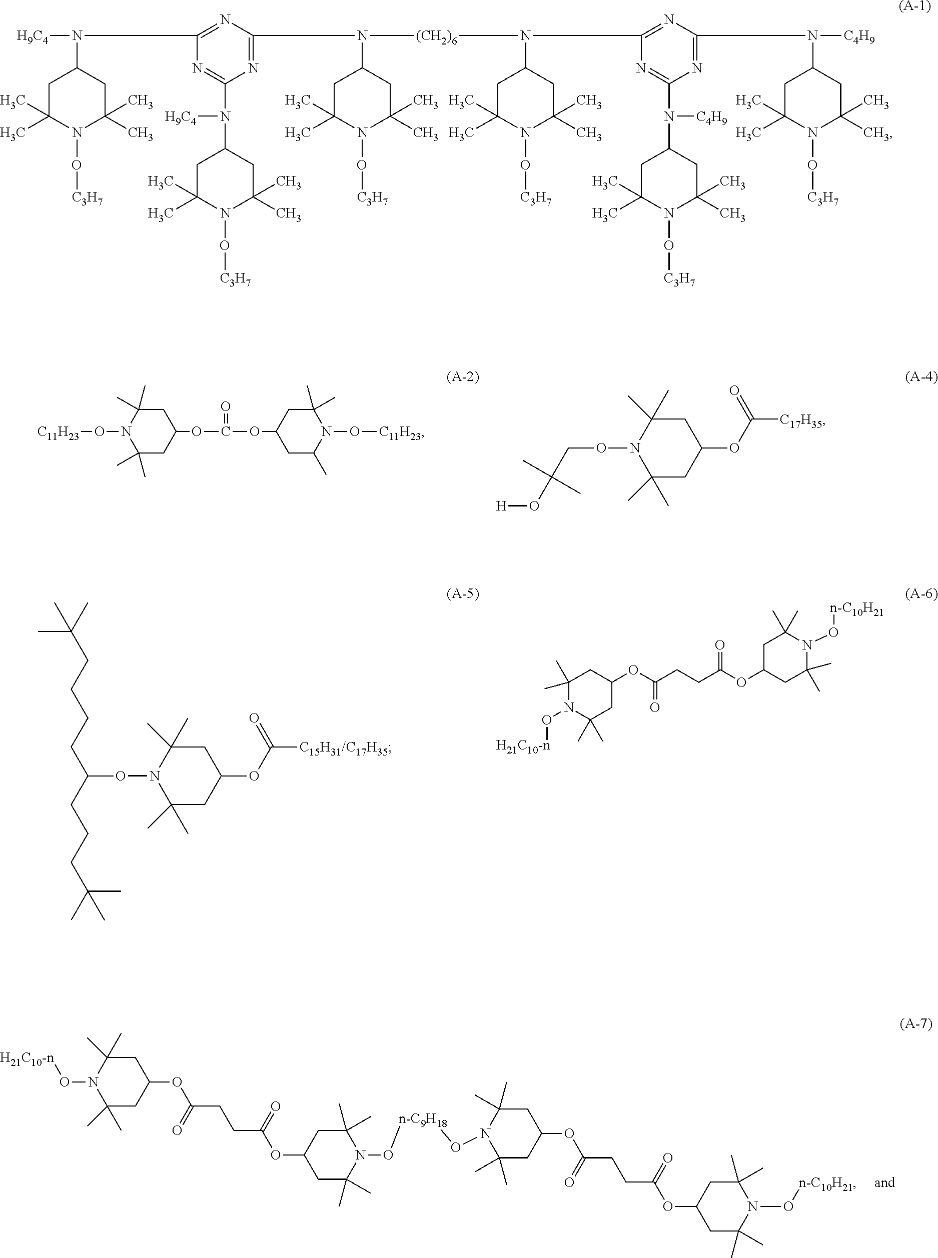

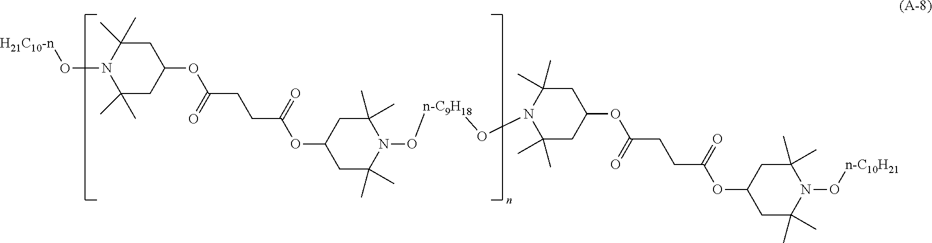

wherein n is 2,
(ii) at least one UV absorber; and
(iii) at least one metal hydroxide.

In another aspect, the presently claimed invention is directed to a composition comprising:
I. an organic material, and
II. a stabilizer mixture, wherein the stabilizer mixture comprises at least one compound (A) is selected from the general formula (A-1), general formula (A-2), general formula (A-4), general formula (A-5), general formula (A-6), general formula (A-7), and general formula (A-8), at least one UV absorber, and at least one metal hydroxide.

In another aspect, the presently claimed invention is directed to an article comprising the composition as defined above.

In still another aspect, the presently claimed invention is directed to the use of the stabilizer mixture, as defined above, for stabilizing an organic material by reducing degradation induced by a chlorine containing compound having the chlorine content in the range of 100 to 600 ppm.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Further-more, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention de-scribed herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

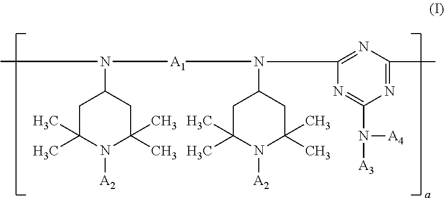

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

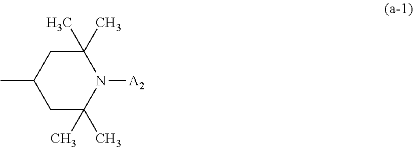

or
A₃ and A₄, together with the nitrogen atom to which they are bonded, form a 5- to 10-membered heterocyclic ring; and
a is an integer in the range of 1 to 20 and the repeating units are the same or different,
   compound (A) of general formula (II)

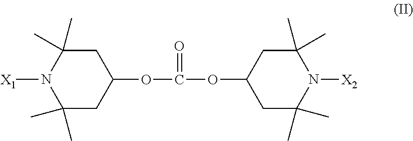

wherein
x₁ and x₂ are independently selected from linear or branched, substituted or unsubstituted C₁ to C₃₀ alkyloxy,
   compound (A) of general formula (III)

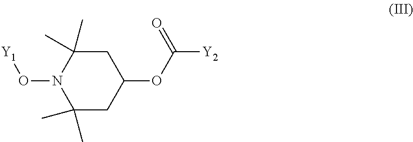

wherein
Y₁ is linear or branched, substituted or unsubstituted C₃ to C₂₀ alkyl,
Y₂ is linear or branched, substituted or unsubstituted C₁ to C₃₀ alkyl; and
   compound (A) of general formula (IV)

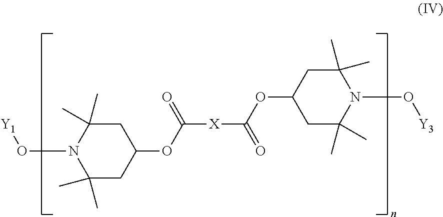

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber; and
(iii) at least one metal hydroxide.

In a preferred embodiment, A₁ is selected from linear or branched, substituted or unsubstituted C₂-C₈ alkylene and substituted or unsubstituted cyclohexylene, A₂ is independently selected from H, linear or branched, substituted or unsubstituted C₁-C₈ alkyl, C₁-C₁₂alkyloxy, substituted or unsubstituted cyclohexyl and cyclohexyloxy, A₃ and A₄ are independently selected from H, linear or branched, substituted or unsubstituted C₁-C₈ alkyl or a group of the formula (a-1) or A₃ and A₄, together with the nitrogen atom to which they are bonded, form a morpholino group, and a is an integer in the range of 1 to 10.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I),

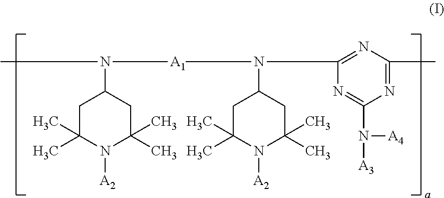

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

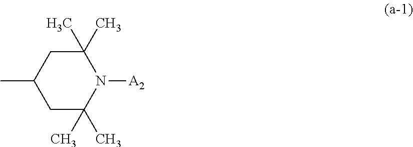

or
A₃ and A₄, together with the nitrogen atom to which they are bonded, form a 5- to 10-membered heterocyclic ring; and
a is an integer in the range of 1 to 20 and the repeating units are the same or different,
(ii) at least one UV absorber; and
(iii) at least one metal hydroxide.

In another embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (II),

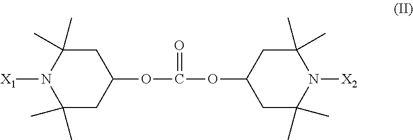

wherein
x₁ and x₂ are independently selected from linear or branched, substituted or unsubstituted C₁ to C₃₀ alkyloxy,
(ii) at least one UV absorber; and
(iii) at least one metal hydroxide.

In another embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (III), compound (A) of general formula (III)

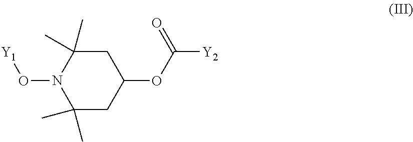

wherein
Y₁ is linear or branched, substituted or unsubstituted C₃ to C₂₀ alkyl,
Y₂ is linear or branched, substituted or unsubstituted C₁ to C₃₀ alkyl;
(ii) at least one UV absorber; and
(iii) at least one metal hydroxide.

In another embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (IV),
   compound (A) of general formula (IV)

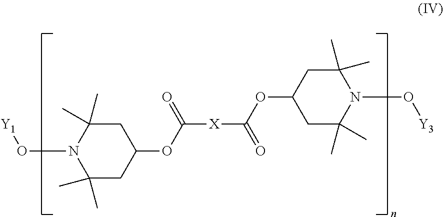

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl, n is an integer in the range of 1 to 8;
(ii) at least one UV absorber; and
(iii) at least one metal hydroxide.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

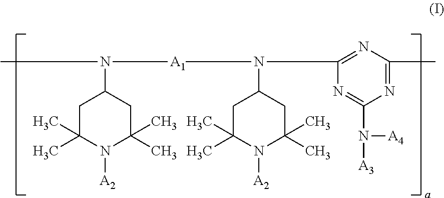

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

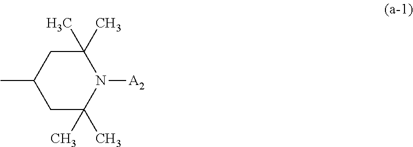

or
A₃ and A₄, together with the nitrogen atom to which they are bonded, form a 5- to 10-membered heterocyclic ring; and
a is an integer in the range of 1 to 20 and the repeating units are the same or different,
   compound (A) of general formula (II)

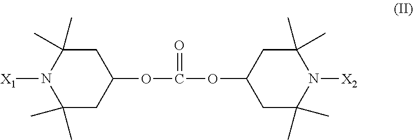

wherein
x₁ and x₂ are independently selected from linear or branched, substituted or unsubstituted C₁ to C₃₀ alkyloxy, and
   compound (A) of general formula (III)

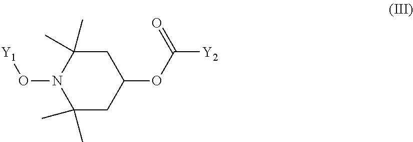

wherein
Y₁ is linear or branched, substituted or unsubstituted C₃ to C₂₀ alkyl,
Y₂ is linear or branched, substituted or unsubstituted C₁ to C₃₀ alkyl; and
(ii) at least one UV absorber; and
(iii) at least one metal hydroxide.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

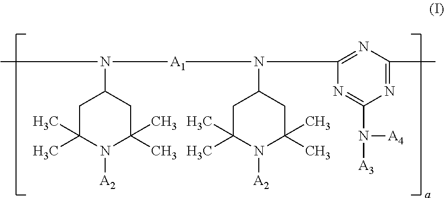

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

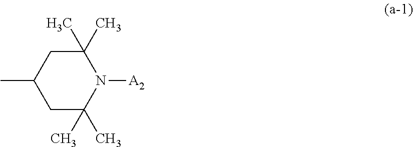

or
A₃ and A₄, together with the nitrogen atom to which they are bonded, form a 5- to 10-membered heterocyclic ring; and
a is an integer in the range of 1 to 20 and the repeating units are the same or different,
   compound (A) of general formula (II)

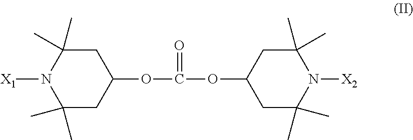

wherein
x₁ and x₂ are independently selected from linear or branched, substituted or unsubstituted C₁ to C₃₀ alkyloxy, and
   compound (A) of general formula (IV)

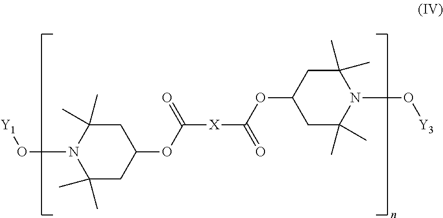

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8;
(ii) at least one UV absorber; and
(iii) at least one metal hydroxide.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

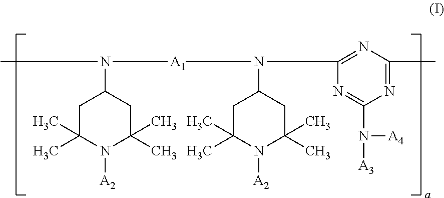

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

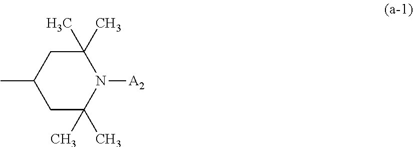

or
A₃ and A₄, together with the nitrogen atom to which they are bonded, form a 5- to 10-membered heterocyclic ring; and
a is an integer in the range of 1 to 20 and the repeating units are the same or different,
   compound (A) of general formula (III)

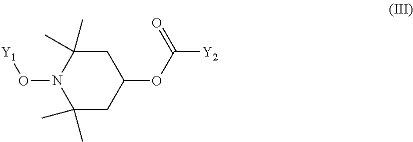

wherein
Y₁ is linear or branched, substituted or unsubstituted C₃ to C₂₀ alkyl,
Y₂ is linear or branched, substituted or unsubstituted C₁ to C₃₀ alkyl; and
   compound (A) of general formula (IV)

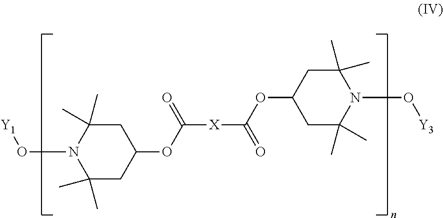

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8;
(ii) at least one UV absorber; and
(iii) at least one metal hydroxide.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

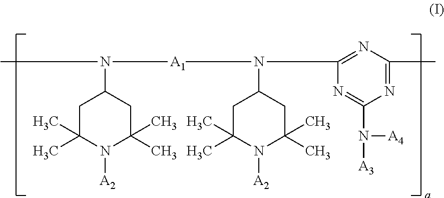

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

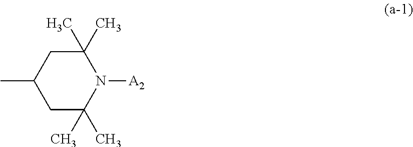

or
A₃ and A₄, together with the nitrogen atom to which they are bonded, form a 5- to 10-membered heterocyclic ring; and
a is an integer in the range of 1 to 20 and the repeating units are the same or different, and
   compound (A) of general formula (II)

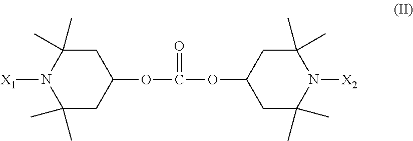

wherein
x₁ and x₂ are independently selected from linear or branched, substituted or unsubstituted C₁ to C₃₀ alkyloxy;
(ii) at least one UV absorber; and
(iii) at least one metal hydroxide.

In an embodiment, the presently claimed invention is directed to a method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
   compound (A) of general formula (I)

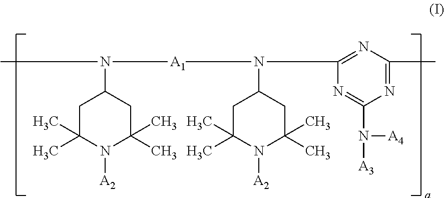

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

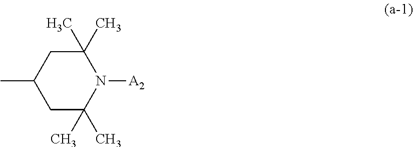

or
A₃ and A₄, together with the nitrogen atom to which they are bonded, form a 5- to 10-membered heterocyclic ring; and
a is an integer in the range of 1 to 20 and the repeating units are the same or different, and
   compound (A) of general formula (III)

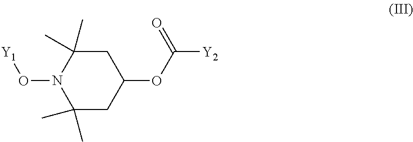

wherein
Y₁ is linear or branched, substituted or unsubstituted C₃ to C₂₀ alkyl,
Y₂ is linear or branched, substituted or unsubstituted C₁ to C₃₀ alkyl; and
(ii) at least one UV absorber; and
(iii) at least one metal hydroxide.

Compound A of General Formula (I):

In an embodiment, the stabilizer mixture comprises at least one compound (A) selected from general formula (I), general formula (II), general formula (III), general formula (IV), and mixtures thereof.

In an embodiment, the stabilizer mixture comprises at least one compound (A) of general formula (I)

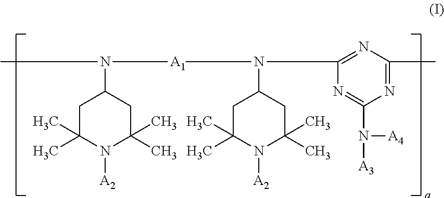

wherein
A₁ is selected from linear or branched, substituted or unsubstituted C₂-C₁₈alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

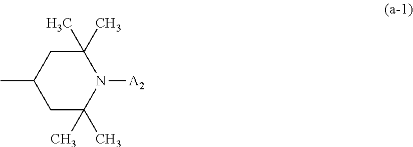

or
A₃ and A₄, together with the nitrogen atom to which they are bonded, form a 5- to 10-membered heterocyclic ring; and
a is an integer in the range of 1 to 20 and the repeating units are the same or different,

Within the context of the present invention, the term alkyl, as used herein, refers to acyclic saturated aliphatic residues, including linear or branched alkyl residues.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₁₂ alkyl include, but are not limited to, methyl, ethyl, n-propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, 2-propyl heptyl, n-octyl, 2-ethylhexyl, 1,1,3-trimethylhexyl, 1,1,3,3-tetramethylpentyl, n-nonyl, n-decyl, n-undecyl, isoundecyl, 1-methylundecyl, n-dodecyl, isododecyl, and 1,1,3,3,5,5-hexamethylhexyl.

Representative examples of C₁-C₁₂alkyloxy include, but are not limited to, methoxy, ethoxy, propoxy, isopropoxy, butoxy, isobutoxy, pentoxy, isopentoxy, hexoxy, heptoxy, octoxy, nonyloxy, decyloxy, undecyloxy, and dodecyloxy.

In a preferred embodiment, alkyloxy is selected from methoxy, ethoxy, propoxy, isopropoxy, butoxy, isobutoxy, pentoxy, isopentoxy, hexoxy, heptoxy and octoxy. In a more preferred embodiment, alkyloxy is propoxy.

Representative examples of C₅-C₁₂ cycloalkyl are cyclopentyl, cyclohexyl, cycloheptyl, cyclooctyl, cyclononyl, cyclodecyl, cycloundecyl, and cyclododecyl.

Representative examples of C₅-C₁₂cycloalkyloxy are cyclopentoxy, cyclohexoxy, cycloheptoxy, cyclooctoxy, cyclononyloxy, cyclodecyloxy, cycloundecyloxy, and cyclododecyloxy.

In a preferred embodiment the cylcoalkyloxy is cyclohexoxy.

A preferred example of phenyl substituted by 1, 2 or 3 C₁-C₄alkyl is 2,4-dimethylphenyl.

Preferred C₂-C₁₈alkylene are ethylene, propylene, trimethylene, tetramethylene, pentamethylene, 2,2-dimethyltrimethylene and hexamethylene. In a more preferred embodiment, alkylene is hexamethylene.

An example of C₅-C₇cycloalkylene is cyclohexylene.

An example of C₁-C₄alkylenedi(C₅-C₇cycloalkylene) is methylenedicyclohexylene.

Examples of the radicals A₃ and A₄ together with the nitrogen atom to which they are bonded, forming a 5- to 10-membered heterocyclic ring, are 1-pyrrolidyl, piperidyl, morpholinyl, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl, preferably morpholinyl.

In the compound (A) of the general formula (I) the terminal group attached to the diamino residue is for example hydrogen or a group of the formula

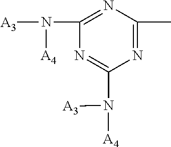

and the terminal group attached to the triazine radical is for example a group of the formula

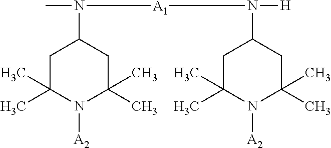

or a group of the formula

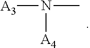

In a preferred embodiment, A₁ is hexamethylene, and A₂ is hydrogen, and propoxy.

In a preferred embodiment, A₃ is butyl,

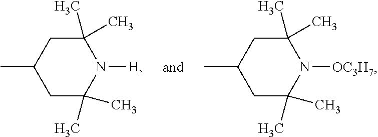

In a preferred embodiment, A₄ is butyl.

In a preferred embodiment, a is an integer in the range of 1 to 10.

Compound A of General Formula (II):

In an embodiment, the stabilizer mixture comprises at least one compound (A) of general formula (II)

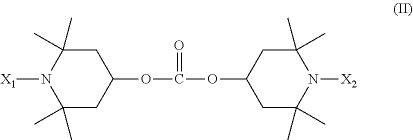

wherein
x₁ and x₂ are independently selected from linear or branched, substituted or unsubstituted C₁ to C₃₀ alkyloxy,

In a preferred embodiment, x₁ and x₂ are independently selected from linear or branched, unsubstituted C₁ to C₃₀ alkyloxy.

Representative examples of linear or branched, unsubstituted C₁ to C₃₀ alkyloxy are methyloxy, ethyloxy, propyloxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, icosyloxy, henicosyloxy, docosyloxy, tricosyloxy, tetracosyloxy, pentacosyloxy, hexacosyloxy, heptacosyloxy, octacosyloxy, nonacosyloxy and triacontyloxy.

In a preferred embodiment, x₁ and x₂ are each undecyloxy.

Compound (A) of General Formula (III):

In an embodiment, the stabilizer mixture comprises at least one compound (A) of general formula (III)

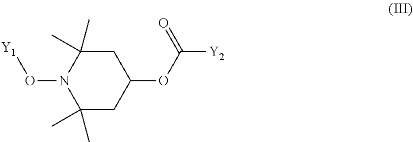

wherein
Y₁ is linear or branched, substituted or unsubstituted C₃ to C₂₀ alkyl,
Y₂ is linear or branched, substituted or unsubstituted C₁ to C₃₀ alkyl; In a preferred embodiment, Y₁ is linear or branched, unsubstituted C₃ to C₂₀ alkyl.

In an embodiment, Y₁ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosyl.

In a preferred embodiment, Y₁ is selected from propyl, and dodecyl.

In a preferred embodiment, Y₂ is linear or branched, unsubstituted C₁ to C₃₀ alkyl.

In an embodiment, Y₂ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

In a preferred embodiment, Y₂ is selected from pentadecyl, and heptadecyl.

Compound (A) of General Formula (IV):

In an embodiment, the stabilizer mixture comprises at least one compound (A) of general formula (IV).

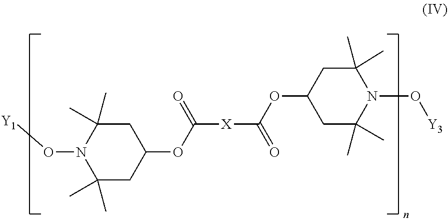

wherein
   Y₁ is linear or branched, substituted or unsubstituted C₃ to C₂₀ alkyl,
   Y₃ is independently selected from linear or branched, substituted or unsubstituted C₃ to C₂₀ alkyl, and C₃ to C₂₀ alkylidene,
   X is linear or branched, substituted or unsubstituted C₂ to C₅ alkyl,
   n is an integer in the range of 1 to 8, and

In a preferred embodiment, Y₃ is selected from linear or branched, unsubstituted C₃ to C₂₀ alkyl and C₃ to C₂₀ alkylidene.

Representative examples of alkylidene having up to 20 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, octadecylidene, nonadecylidene, and icosylidene.

In a preferred embodiment, Y₁ is selected from decyl.

In a preferred embodiment, Y₃ is selected from decyl, and nonylidene.

In a preferred embodiment, the stabilizer mixture comprises:
(i) at least one compound (A) selected from general formula (I), wherein A₁ is selected from C₂-C₁alkylene, C₅-C₂cycloalkylene and C₁-C₄alkylenedi(C₅-C₂cyclo alkylene), A₂ is independently selected from C₁-C₁₂ alkyloxy, and C₅-C₁₂cycloalkyloxy, A₃ and A₄ is independently selected from H, C₁-C₁₂ alkyl, C₅-C₁₂ cycloalkyl and a group of the formula (a-1), or A₃ and A₄, together with the nitrogen atom to which they are bonded, form a 5- to 10-membered heterocyclic ring, and a is an integer in the range of 1 to 20 and the repeating units are the same or different,
   general formula (II), general formula (III), general formula (IV), and mixtures thereof;
(ii) at least one UV absorber; and
(iii) at least one metal hydroxide.

In another preferred embodiment, the stabilizer mixture comprises:
(i) at least one compound (A) selected from general formula (I), wherein A₁ is selected from C₂-C₁₈ alkylene, C₅-C₇ cycloalkylene, and C₁-C₄ alkylenedi(C₅-C₇ cyclo alkylene), A₂ is independently selected from H, C₁-C₁₂ alkyl, and C₅-C₁₂ cycloalkyl, A₃ and A₄ is independently selected from H, C₁-C₁₂alkyl, C₅-C₁₂ cycloalkyl and a group of the formula (a-1), or A₃ and A₄, together with the nitrogen atom to which they are bonded, form a 5- to 10-membered heterocyclic ring; and a is an integer in the range of 1 to 20 and the repeating units are the same or different,
   general formula (II), general formula (III), general formula (IV), and mixtures thereof;
(ii) at least one UV absorber; and
(iii) at least one metal hydroxide.

In a preferred embodiment, the compound (A) is at least one compound selected from the formula (A-1), (A-2), (A-3), (A-4), (A-5), (A-6), (A-7), and (A-8)

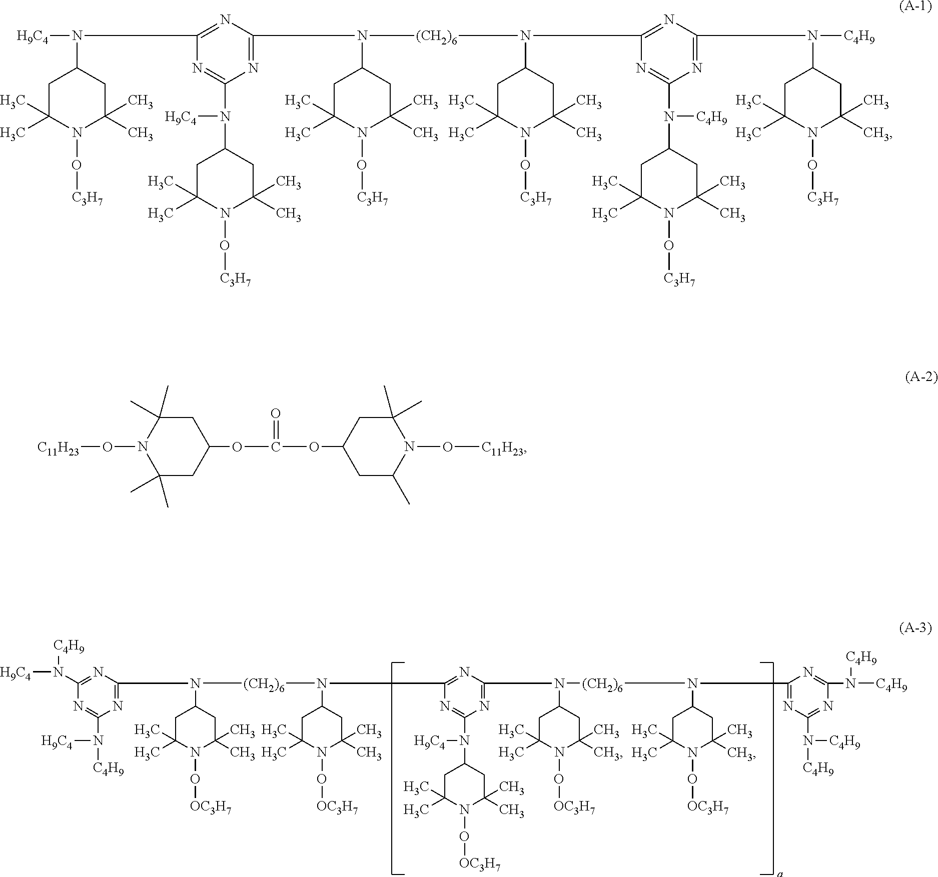

wherein a is an integer in the range of 1 to 10,

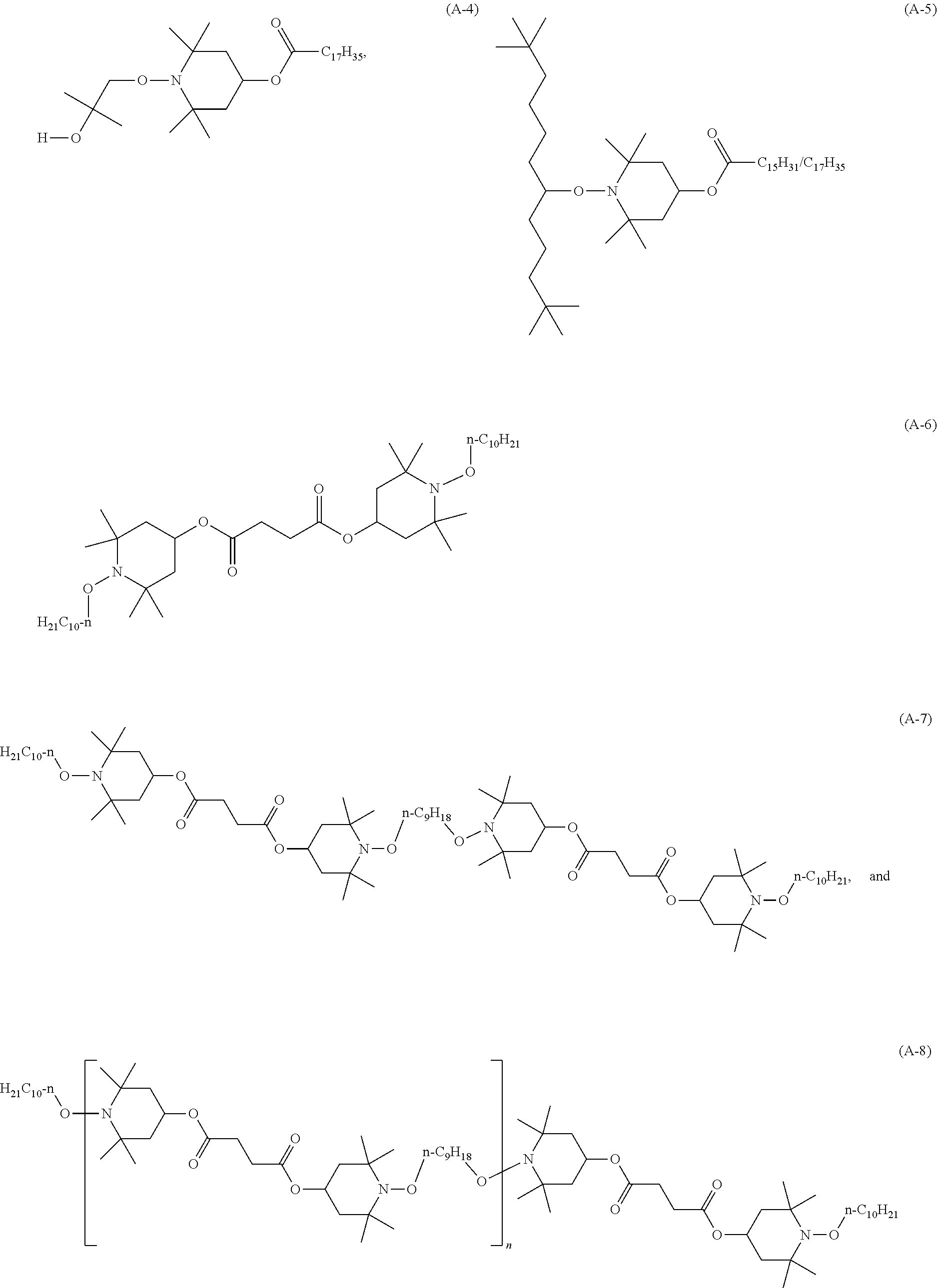

wherein n is 2.

In a more preferred embodiment, the compound (A) is at least one compound selected from the formula (A-1), (A-3), (A-4), (A-5), (A-6), (A-7), and (A-8).

In another preferred embodiment, the compound (A) is a compound of formula (A-9)

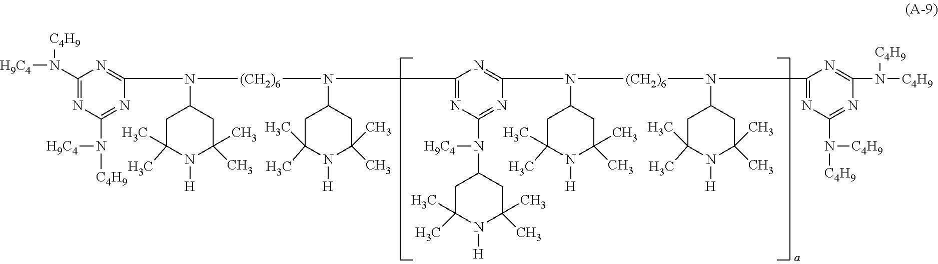

wherein a is an integer in the range of 1 to 10.

Organic Material

In an embodiment, the organic material is selected from:
1. Polymers of monoolefins and diolefins, for example polyethylene, polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or a form fixed on substrates, typically on substrates such as activated magnesium chloride, titanium (III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereo structure including syndiotactic, isotactic, hemi-isotactic or atactic; where polymers atactic stereostructure are preferred. Stereoblock polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.
7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
17. Polyureas, polyimides, polyamide-imides, polyetherimides, polyesterimides, polyhydantoins and polybenzimidazoles.
18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylenesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lactide and any mixtures thereof.
19. Polycarbonates and polyester carbonates.
20. Polyketones.
21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
31. Aqueous emulsions of natural or synthetic rubber, e.g. natural latex or latices of carboxylated styrene/butadiene copolymers.

In a preferred embodiment, the organic material is selected from linear low-density polyethylene, low-density polyethylene, high density polyethylene, ethylene-vinyl acetate copolymer, ethylene-butyl acrylate copolymer, polypropylene homopolymer and polypropylene copolymer.

In a more preferred embodiment, the organic material is low-density polyethylene.

Chlorine Containing Compound

In an embodiment, the presently claimed invention is directed to a method for stabilizing an organic material by reducing degradation induced by a chlorine containing compound having a chlorine content in the range of 100 to 600 ppm.

The chlorine containing compound can be an agrochemical compound or a bleaching agent.

The agrochemical compound can be an insecticide, fungicide, nematicide, and mixtures thereof.

The agrochemical compound is selected from pyrethroid, dicarboximide, ClCH₂—CH═CHCl, Cl₃C—NO₂, pyrethroid, phthalimide, benzoylurea, imidazole, and mixtures thereof.

The agrochemical compound is selected from permethrin, procymidone, 1,3-dichloropropene, chloropicrin, γ-cyhalothrin, captan, teflubenzuron, prochloraz, and mixtures thereof.

The bleaching agent is sodium hypochlorite, chlorine dioxide, and chloramines, preferably sodium hypochlorite.

UV Absorber In an embodiment, the stabilizer mixture comprises at least one UV absorber.

In an embodiment, the at least one UV absorber is selected from 2-(2′-hydroxyphenyl)benzotriazoles, 2-hydroxybenzophenones, 2-(2-hydroxyphenyl)-1,3,5-triazines and mixtures thereof.

In an embodiment, the 2-(2′-hydroxyphenyl)benzotriazole is selected from 2-(2H-Benzotriazol-2-yl)-4,6-bis(1-methyl-1-phenylethyl)phenol, 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole,2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

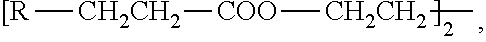

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; and 2-[2′-hydroxy-3′-(1,1,3,3-tetramethylbutyl)-5′-(α,α-dimethylbenzyl)-phenyl]benzotriazole, and mixtures thereof.

In a preferred embodiment, the 2-(2′-hydroxyphenyl)benzotriazole is 2-(2′-hydroxy-5′-(1,1,3,3-tetramethylbutyl)phenyl)benzotriazole.

In an embodiment, the 2-hydroxybenzophenone is selected from 4-hydroxy, 4-methoxy, 4-octyloxy, 4-decyloxy, 4-dodecyloxy, 4-benzyloxy, 4,2′,4′-trihydroxy, 2′-hydroxy-4,4′-dimethoxy derivatives and mixtures thereof.

In an embodiment, the 2-(2-hydroxyphenyl)-1,3,5-triazine is selected from 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-[2-hydroxy-4-[3-(2-ethylhexyl-1-oxy)-2-hydroxypropyloxy]phenyl)-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2,4-bis(4-biphenylyl)-6-[2-hydroxy-4-(2-ethylhexyloxy)phenyl]-1,3,5-triazine, Dodecanedioic acid, 1,12-bis[2-[4-(4,6-diphenyl-1,3,5-triazin-2-yl)-3-hydroxyphenoxy]ethyl]ester and mixtures thereof.

In a preferred embodiment, the 2-(2-hydroxyphenyl)-1,3,5-triazine is 2,4-bis(4-biphenylyl)-6-[2-hydroxy-4-(2-ethylhexyloxy)phenyl]-1,3,5-triazine.

Metal Hydroxide

In an embodiment, the stabilizer mixture comprises at least one metal hydroxide.

In an embodiment, the at least one metal hydroxide is selected from the group consisting of hydrotalcite, and magnesium hydroxide.

Hydrotalcite

In a preferred embodiment, the hydrotalcite is a mixed hydroxide of the formula (Z-I) or (Z-II).

M²⁺_{1-g}M³⁺_{g}(OH)₂(A^{b-})_{g/b}×cH₂O (Z-1)

M²⁺_{d}Al³⁺₂(OH)_{2d+6-eb}(A^{b-})ₑ×fH₂O (Z-II)
M² is selected from Ca²⁺, Mg²⁺, Sr²⁺, Ba²⁺, Zn²⁺, Pb²⁺, Sn²⁺ and Ni²⁺.
M³⁺ is selected from Al³⁺, B³⁺ and Bi³⁺.
g is a number up to 0.5.
A^{b-} is an anion of valency b, selected from Cl⁻, Br⁻, NO³⁻, CO₃²⁻, SO₄²⁻ or SeO₄²⁻.
b is an integer from 1 to 4.
c is zero, 1 or 2.
d is a number up to 6.
e is a number up to 2.
f is zero or a number up to 15.

In a more preferred embodiment, hydrotalcites are layered double hydroxides that contain positively charged hydroxide layers and charge balancing anions located in the interlayer region.

In an even more preferred embodiment, hydrotalcite is at least one magnesium aluminum hydroxide carbonate hydrate which is for example commercially available as Hycite® 713,®DHT-4A,®DHT-4V,®DHT-4A-2,®DHT-4C or Sorbacid® 911, or zinc aluminum hydroxide carbonate hydrate which is for example commercially available as ®ZHT-4V or Sorbacid® 944, or mixtures thereof.

In a most preferred embodiment, hydrotalcite is a magnesium aluminum hydroxide carbonate hydrate which is for example commercially available as Hycite® 713 or DHT-4A.

In another aspect, the presently claimed invention is directed to a stabilizer mixture comprising:
(i) at least one compound (A) selected from the general formula (A-1), general formula (A-2), general formula (A-4), general formula (A-5), general formula (A-6), general formula (A-7), and general formula (A-8);
(ii) at least one UV absorber; and
(iii) at least one metal hydroxide.

In a preferred embodiment, the stabilizer mixture comprises:
(i) at least one compound (A) selected from the general formula (A-1), general formula (A-4), general formula (A-5), general formula (A-6), general formula (A-7), and general formula (A-8);
(ii) at least one UV absorber; and
(iii) at least one metal hydroxide.

In an embodiment, the weight ratio of the at least one compound (A) to the at least one UV absorber is in the range of 1:1 to 20:1, preferably is in the range of 5:1 to 15:1, more preferably is in the range of 9:1 to 13:1, and most preferably is in the range of 11.7:1.

In an embodiment, the weight ratio of the at least one compound (A) to the at least one metal hydroxide is in the range of 1:10 to 10:1, preferably is in the range of 1:5 to 5:1, more preferably is in the range of 1:3 to 3:1, and most preferably is in the range of 2.5:1.

In an embodiment, the weight ratio of the at least one UV absorber to the at least one hydroxide is in the range of 10:1 to 1:20, preferably is in the range of 5:1 to 1:15, more preferably is in the range of 3:1 to 1:10, and most preferably is in the range of 1:4.7.

Light Stabilizer:

In an embodiment, the stabilizer mixture further comprises at least one light stabilizer.

In an embodiment, the light stabilizer is selected from bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tertoctylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 5-(2-ethylhexanoyl)oxymethyl-3,3,5-trimethyl-2-morpholinone, Sanduvor, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-striazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, and mixtures thereof.

In a preferred embodiment, the light stabilizer is condensate of 1-(2-hydroxyethyl)-2,2,6,6-tetramethyl-4-hydroxypiperidine and succinic acid.

In another aspect, the presently claimed invention is directed to a composition comprising:
I. an organic material, and
II. a stabilizer mixture as defined above.

In an embodiment, the weight ratio of the organic material to the stabilizer mixture is in the range of 0.005:10%, preferably 0.005:5%, more preferably 0.01:2.5%, and most preferably 0.05:2%, relative to the weight of the organic material.

The individual components of the present stabilizer mixture may be added to the organic material to be stabilized either individually or mixed with one another. They can be added to a polymer before, during or after the polymerization or before or after the crosslinking.

The composition according to the present invention or its individual components can be incorporated into the organic material to be stabilized by known methods, for example before or during shaping or by applying the dissolved or dispersed stabilizer to the organic material, if necessary, with subsequent evaporation of the solvent. The stabilizers can be added to the organic material in the form of a powder, granules or a masterbatch, which contains said stabilizers in, for example, a concentration of from 2.5 to 90%, preferably 2.5 to 25%, by weight.

Examples of Processing or Transformation of the Materials Stabilized According to the Present Invention are:

Injection blow molding, extrusion, blow molding, rotomolding, in mold decoration (back injection), slush molding, injection molding, co-injection molding, forming, compression molding, pressing, film extrusion (cast film; blown film), fiber spinning (woven, non-woven), drawing (uniaxial, biaxial), annealing, deep drawing, calandering, mechanical transformation, sintering, coextrusion, coating, lamination, crosslinking (radiation, peroxide, silane), vapor deposition, weld together, glue, vulkanization, thermoforming, pipe extrusion, profile extrusion, sheet extrusion; sheet casting, spin coating, strapping, foaming, recycling/rework, extrusion coating, visbreaking (peroxide, thermal), fibre melt blown, spun bonded, surface treatment (corona discharge, flame, plasma), sterilization (by gamma rays, electron beams), cast polymerization (R&M process, RAM extrusion), gel-coating, tape extrusion, GMT-process, SMC-process, plastisol, and dipping (PVC, latex).

Additive (A)

In an embodiment, the composition further comprising at least one additive (A) selected from antioxidants, UV absorber, slip agents, anti-block agents, thermal fillers, pigments, anti-fog agents, anti-mist agents and additional additives (B).
1. Antioxidants
1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-ditert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tertbutyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, 6-tocopherol and mixtures thereof (vitamin E).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tertbutylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-ditert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tertbutyl-4-hydroxyphenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N(3,5-di-tert-butyl-4-hydroxyphenyl)carbamate.
1.13. Esters of β-(3,5-di-tert-butyl-4-hydroxyphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tertbutyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).
1.18. Ascorbic acid (vitamin C)
1.19. Aminic antioxidants, for example N,N′-di-isopropyl-p-phenylenediamine, N,N′-di-secbutyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tertbutyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.
2. UV absorbers and light stabilizers

The composition may comprise UV absorbers, in addition to those disclosed above.
2.1. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.2. Acrylates, for example ethyl α-cyano-β,β-diphenylacrylate, isooctyl α-cyano-β,β-diphenylacrylate, methyl α-carbomethoxycinnamate, methyl α-cyano-β-methyl-pmethoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.
2.3. Nickel compounds, for example nickel complexes of 2,2′-thio-bis[4-(1,1,3,3-tetramethylbutyl)phenol], such as the 1:1 or 1:2 complex, with or without additional ligands such as nbutylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tertbutylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.4. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Additive (B)
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS: 939402-02-5), phosphorous acid, triphenyl ester, polymer with α-hydro-ω-hydroxypoly[oxy(methyl-1,2-ethanediyl)], C₁₀₋₁₆-alkyl esters (CAS: 1227937-46-3).

The following phosphites are especially preferred:

Tris(2,4-di-tert-butylphenyl) phosphite, tris(nonylphenyl) phosphite,

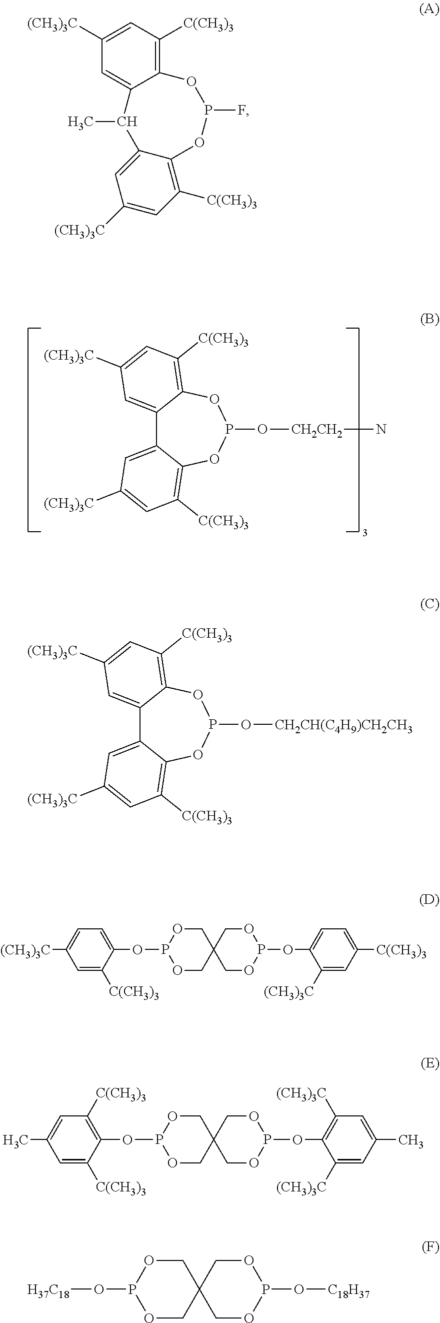

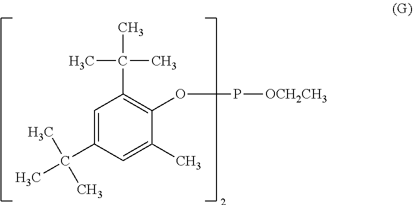

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecylalpha-heptadecylnitrone, N-ocatadecyl-alpha-pentadecylnitrone, N-heptadecyl-alphaheptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(b-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, for example 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.
12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibres of other natural products, synthetic fibres.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. Nos. 4,325,863; 4,338,244; 5,175,312; 5,216,052; 5,252,643; DE-A-4316611;
DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

In another aspect, the presently claimed invention is directed to an article comprising the composition as described above.

In an embodiment, the article is a monolayer film or a multilayer film of three to twelve layers, having a total thickness of 100 to 300 microns, preferably 120 to 220 microns, more preferably 150 to 180 microns, most preferably 160 microns.

The multilayer film contains at least one compound (A) in at least one layer, and at least one compound of the UV absorber and a compound of the at least one metal hydroxide independently in another layers.

Such a multilayer film is typically made of three, five, seven, nine or eleven layers. This can lead to a film structure like (A-3)-(B-1)-(B-2)-(C-1)-(C-2), (A-3)-(B-1)-(B-2)-(C-1)-(C-3), (A-3)-(B-3)-(A-2)-(B-1)-(B-2)-(C-1)-(C-2), and (A-3)-(B-3)-(A-4)-(B-1)-(B-2)-(C-1)-(C-2). Compounds such as (A-3), (B-3), (A-4), (B-1), (B-2), (C-1), and (C-2) are described in the examples.

However, adjacent layers can also be coupled so that the final film article can be made of an even number of layers, i.e. two, four, six, eight, ten or twelve layers such as (A-3)-(B-1)-(B-2)-(C-1), (A-3)-(B-1)-(B-2)-(C-2), and (A-3)-(B-1)-(B-2)-(C-2) and the like.

In a preferred embodiment, the article is a greenhouse film cover, mulch film, artificial turfs, or geomembrane.

In a more preferred embodiment, the greenhouse film cover, mulch film, artificial turf, or geomembrane is in contact with an agrochemical compound or bleaching agent.

In another aspect, the present invention is directed to a use of the stabilizer mixture for stabilizing an organic material by reducing degradation induced by a chlorine containing compound having the chlorine content in the range of 100 to 600 ppm.

In an embodiment, the stabilizer mixture is used for stabilizing an organic material by reducing degradation induced by light, heat, or oxidation.

The organic materials stabilized according to this invention is used in a wide variety of forms, for example as films, fibres, tapes, moulding compositions, profiles or as binders for paints, adhesives or putties.

In more detail, the organic materials stabilized according to the present invention may be used for the preparation of the following devices:
I-1) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.
I-2) Devices for plane, railway, motor car (car, motorbike) including furnishings.
I-3) Devices for space applications, in particular rockets and satellites, e.g. reentry shields.
I-4) Devices for architecture and design, mining applications, acoustic quietized systems, street refuges, and shelters.
II-1) Electric appliances, in particular washing machines, tumblers, ovens (microwave oven), dishwashers, mixers, and irons.
II-2) Foils for condensers, refrigerators, heating devices, air conditioners, encapsulating of electronics, semi-conductors, coffee machines, and vacuum cleaners.
III-1) Technical articles such as cogwheel (gear), slide fittings, spacers, screws, bolts, handles, and knobs.
III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.
III-3) Profiles of any geometry (window panes) and siding.
III-4) Glass substitutes, in particular extruded plates, glazing for buildings (monolithic, twin or multiwall), aircraft, schools, extruded sheets, window film for architectural glazing, train, transportation, sanitary articles, and greenhouse.
III-5) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.
III-6) Cement-, concrete-, composite-applications and covers, siding and cladding, hand rails, banisters, kitchen work tops, roofing, roofing sheets, tiles, and tarpaulins.
IV-1) Plates (walls and cutting board), trays, artificial grass, astroturf, artificial covering for stadium rings (athletics), artificial floor for stadium rings (athletics), and tapes.
V-1) Plastic films in general (packaging, dump, laminating, swimming pools covers, waste bags, wallpaper, stretch and shrink wrap, raffia, desalination film, batteries, and connectors).
V-2) Agricultural films (greenhouse covers, tunnel, mulch, silage, bale wrap), especially in presence of intensive application of agrochemicals having high chlorine content.
VI-1) Food packing and wrapping (flexible and solid), BOPP, BOPET, bottles.
VI-2) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.
VII-1) Devices of filled polymers (talc, chalk, china clay (kaolin), wollastonite, pigments, carbon black, TiO₂, mica, nanocomposites, dolomite, silica, silicates, glass, asbestos).

The presently claimed invention offers one or more of following advantages:
1. The multilayer film prepared in accordance with the method of the present invention exhibits high stability by reducing degradation induced by the high level of chlorine containing compounds.
2. The multilayer film prepared with the stabilizer mixtures of the present invention exhibit a substantial improvement in the elongation at break property of the film.
3. The articles prepared in accordance with the present invention are stable and has long lasting application by reducing degradation induced by the high level of chlorine containing compounds, hence use of these articles are economic.

In the following, specific embodiments of the presently claimed invention are described:
1. A method for stabilizing an organic material by reducing degradation induced by a chlorine containing compound having a chlorine content in the range of 100 to 600 ppm, wherein the method comprises incorporating into the organic material a stabilizer mixture comprising:
   (i) at least one compound (A) selected from general formula (I), general formula (II), general formula (III), general formula (IV), and mixtures thereof,
      compound (A) of general formula (I)

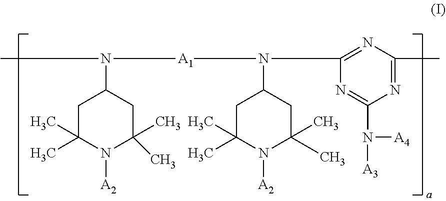

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

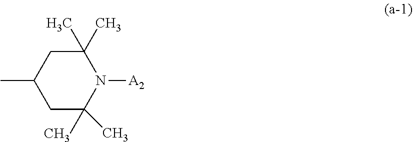

or
A₃ and A₄, together with the nitrogen atom to which they are bonded, form a 5- to 10-membered heterocyclic ring; and
a is an integer in the range of 1 to 20 and the repeating units are the same or different,
compound (A) of general formula (II)

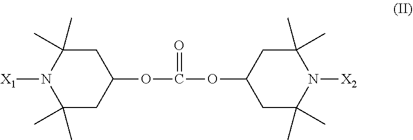

wherein
x₁ and x₂ are independently selected from linear or branched, substituted or unsubstituted C₁ to C₃₀ alkyloxy,
compound (A) of general formula (III)

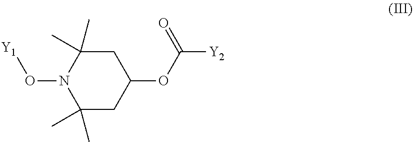

wherein
Y₁ is linear or branched, substituted or unsubstituted C₃ to C₂₀ alkyl,
Y₂ is linear or branched, substituted or unsubstituted C₁ to C₃₀ alkyl; and
compound A of general formula IV

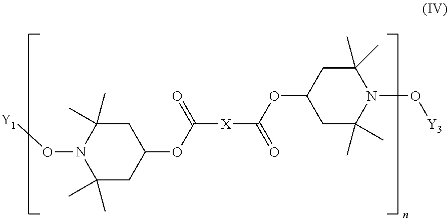

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8, and
(ii) at least one UV absorber; and
(iii) at least one metal hydroxide.
2. The method according to embodiment 1, wherein the organic material is selected from linear low-density polyethylene, low-density polyethylene, high density polyethylene, ethylene-vinyl acetate copolymer, ethylene-butyl acrylate copolymer, polypropylene homopolymer and polypropylene copolymer.
3. The method according to embodiment 1, wherein the organic material is selected from linear low-density polyethylene, low-density polyethylene, high density polyethylene, ethylene-vinyl acetate copolymer, and ethylene-butyl acrylate copolymer.
4. The method according to embodiment 1, wherein the chlorine containing compound is selected from an agrochemical compound and a bleaching agent.
5. The method according to embodiment 1, wherein A₁ is selected from linear or branched, substituted or unsubstituted C₂-C₈ alkylene and substituted or unsubstituted cyclohexylene, A₂ is independently selected from H, linear or branched, substituted or unsubstituted C₁-C₈ alkyl, C₁-C₁₂alkyloxy, substituted or unsubstituted cyclohexyl and cyclohexyloxy, A₃ and A₄ are independently selected from H, linear or branched, substituted or unsubstituted C₁-C₈ alkyl or a group of the formula (a-1) or A₃ and A₄, together with the nitrogen atom to which they are bonded, form a morpholinyl group, and a is an integer in the range of 1 to 10.
6. The method according to one or more of embodiments 1 to 5, wherein the stabilizer mixture comprises:
   (i) at least one compound (A) selected from general formula (I), general formula (II), general formula (III), general formula (IV), and mixtures thereof
      compound (A) of general formula (I)

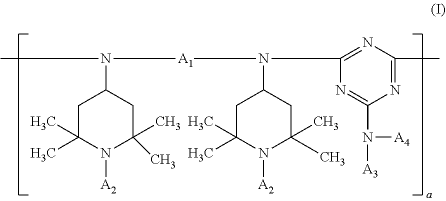

wherein
A₁ is selected from linear or branched, substituted or unsubstituted C₂-C₁₈alkylene, substituted or unsubstituted C₅-C₇ cycloalkylene and C₁-C₄alkylenedi(C₅-C₇ cyclo alkylene),
A₂ is independently selected from linear or branched, substituted or unsubstituted C₁-C₁₂ alkyloxy, and substituted or unsubstituted C₅-C₁₂cycloalkyloxy,
A₃ and A₄ are independently selected from H, linear or branched, substituted or unsubstituted C₁-C₁₂alkyl, substituted or unsubstituted C₅-C₁₂cycloalkyl and a group of the formula (a-1),

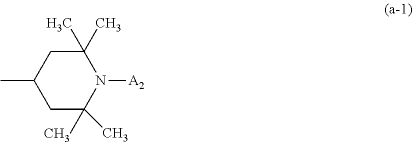

or
A₃ and A₄, together with the nitrogen atom to which they are bonded, form a 5- to 10-membered heterocyclic ring; and
a is an integer in the range of 1 to 20 and the repeating units are the same or different,
compound (A) of general formula (II)

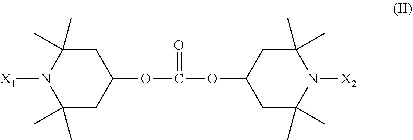

wherein
x₁ and x₂ is independently selected from linear or branched, substituted or unsubstituted C₁ to C₃₀ alkyloxy,
compound (A) of general formula (III)

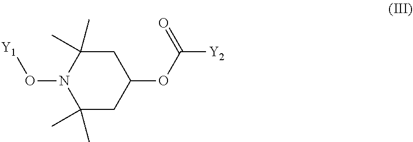

wherein
Y₁ is linear or branched, substituted or unsubstituted C₃ to C₂₀ alkyl,
Y₂ is linear or branched, substituted or unsubstituted C₁ to C₃₀ alkyl; and
compound (A) of general formula (IV)

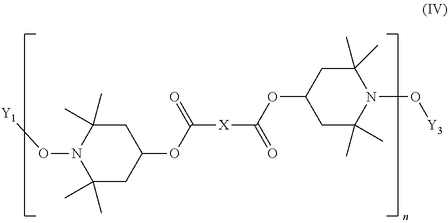

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber, and
(iii) at least one metal hydroxide.
7. The method according to one or more of embodiments 1 to 6, wherein the stabilizer mixture comprises:
   (i) at least one compound (A) selected from general formula (I), general formula (II), general formula (III), general formula (IV), and mixtures thereof,
      compound (A) of general formula (I)

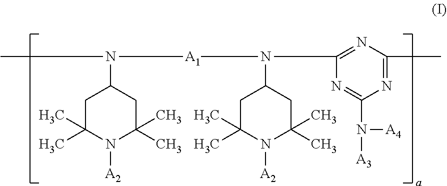

wherein
A₁ is selected from linear or branched, substituted or unsubstituted C₂-C₁alkylene, substituted or unsubstituted C₅-C₇ cycloalkylene, and C₁-C₄alkylenedi(C₅-C₇ cyclo alkylene),
A₂ is independently selected from H, linear or branched, substituted or unsubstituted C₁-C₁₂ alkyl, and substituted or unsubstituted C₅-C₁₂ cycloalkyl,
A₃ and A₄ are independently selected from H, linear or branched, substituted or unsubstituted C₁-C₁₂alkyl, substituted or unsubstituted C₅-C₁₂cycloalkyl and a group of the formula (a-1),

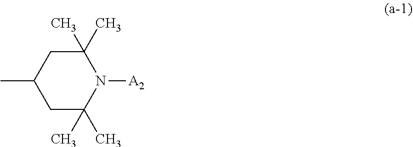

or A₃ and A₄, together with the nitrogen atom to which they are bonded, form a 5- to 10-membered heterocyclic ring; and
a is an integer in the range of 1 to 20 and the repeating units are the same or different,
compound (A) of general formula (II)

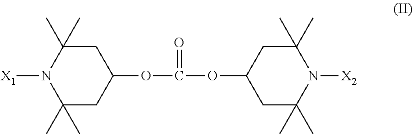

wherein
x₁ and x₂ are independently selected from linear or branched, substituted or unsubstituted C₁ to C₃₀ alkyloxy,
compound (A) of general formula (III)

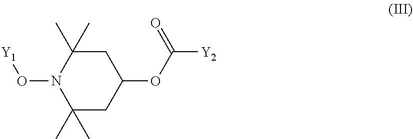

wherein
Y₁ is linear or branched, substituted or unsubstituted C₃ to C₂₀ alkyl,
Y₂ is linear or branched, substituted or unsubstituted C₁ to C₃₀ alkyl; and
compound A of general formula IV

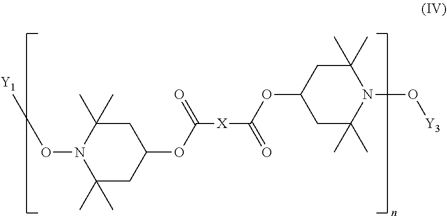

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber; and
(iii) at least one metal hydroxide.
8. The method according to one or more of embodiments 1 to 7, wherein the compound (A) is at least one compound selected from the formula (A-1), (A-2), (A-3), (A-4), (A-5), (A-6), (A-7), and (A-8)

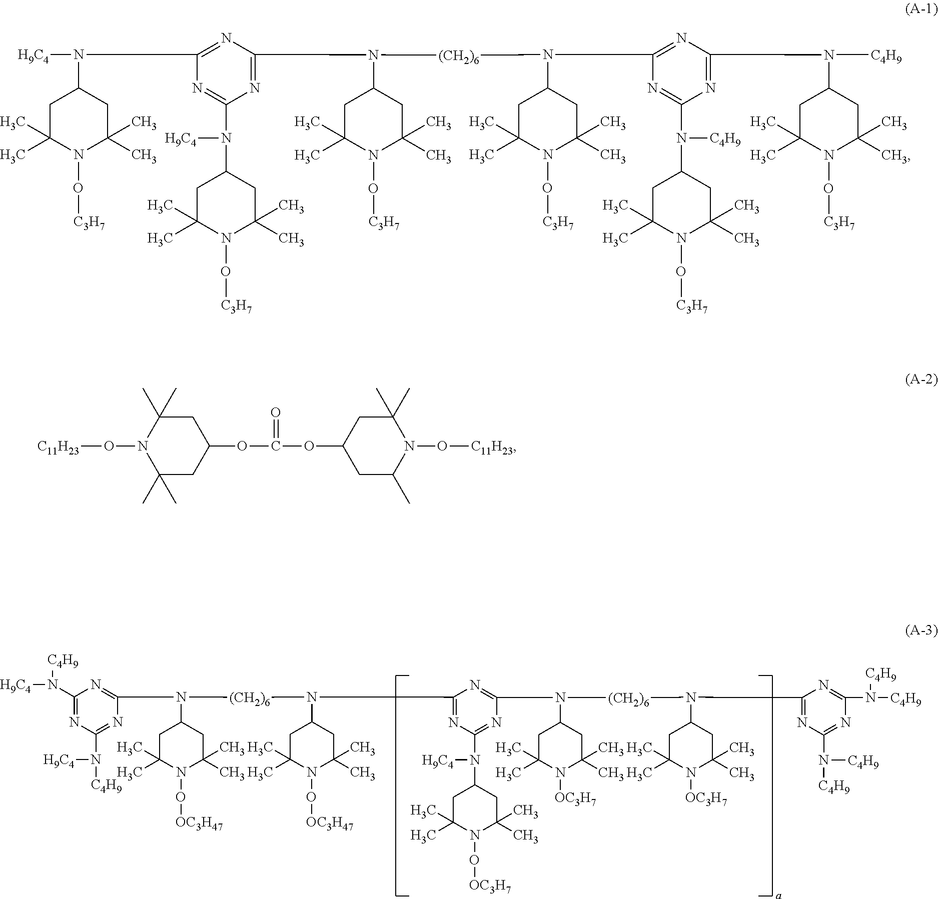

wherein a is an integer in the range of 1 to 10,

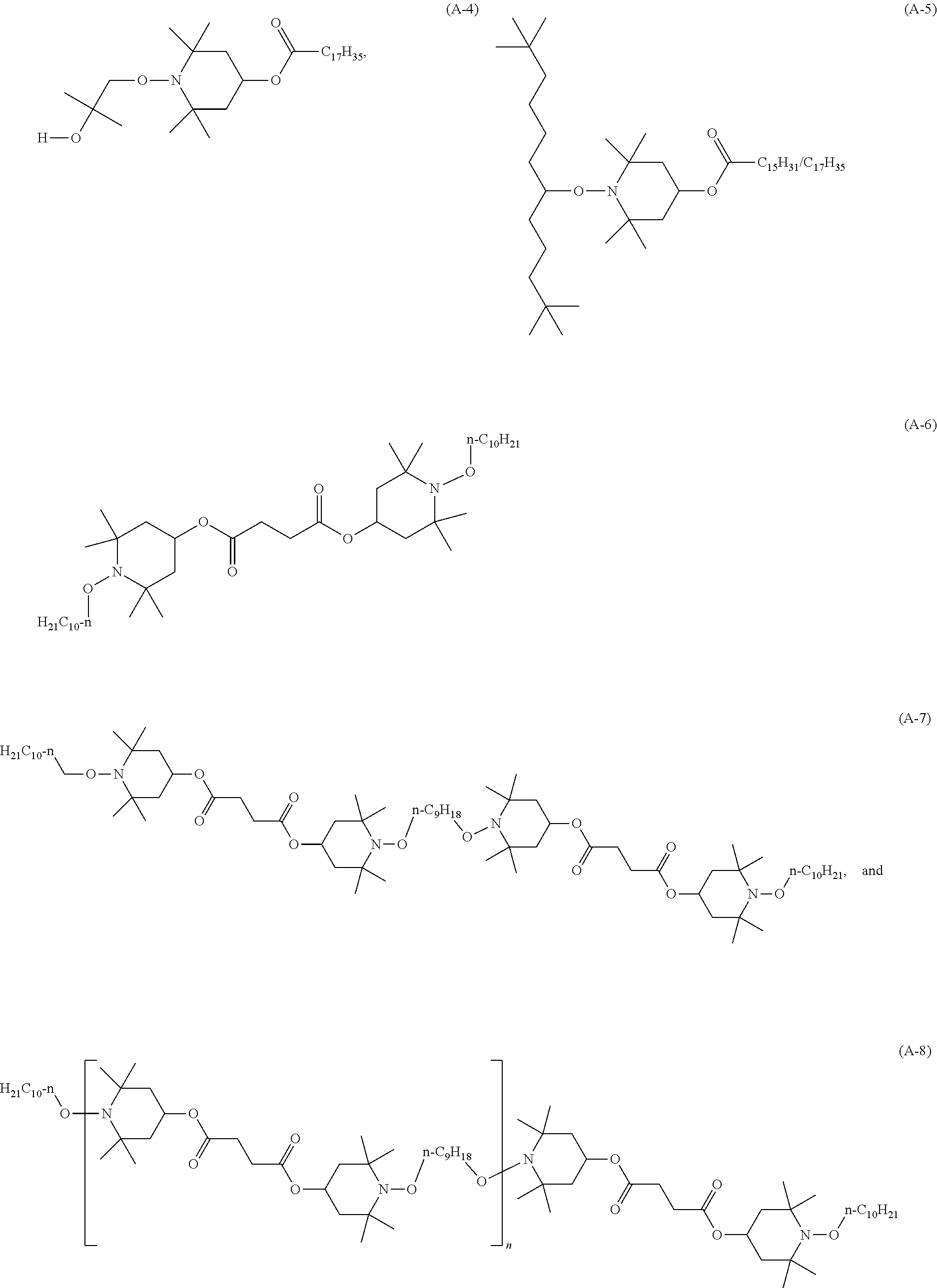

wherein n is 2.
9. The method according to one or more of embodiments 1 to 7, wherein the compound (A) is a compound of formula (A-9)

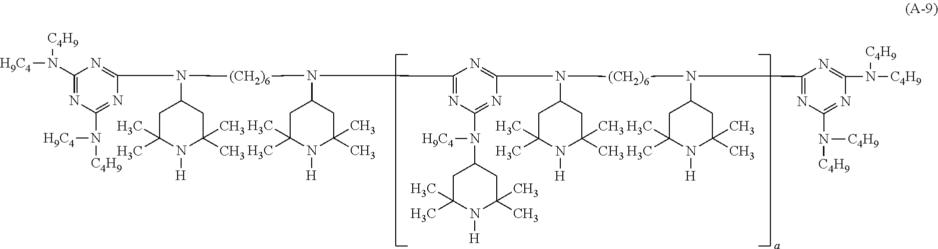

wherein a is an integer in the range of 1 to 10.
10. A stabilizer mixture comprising:
   (i) at least one compound (A) selected from the general formula (A-i), general formula (A-2), general formula (A-4), general formula (A-5), general formula (A-6), general formula (A-7), and general formula (A-8)

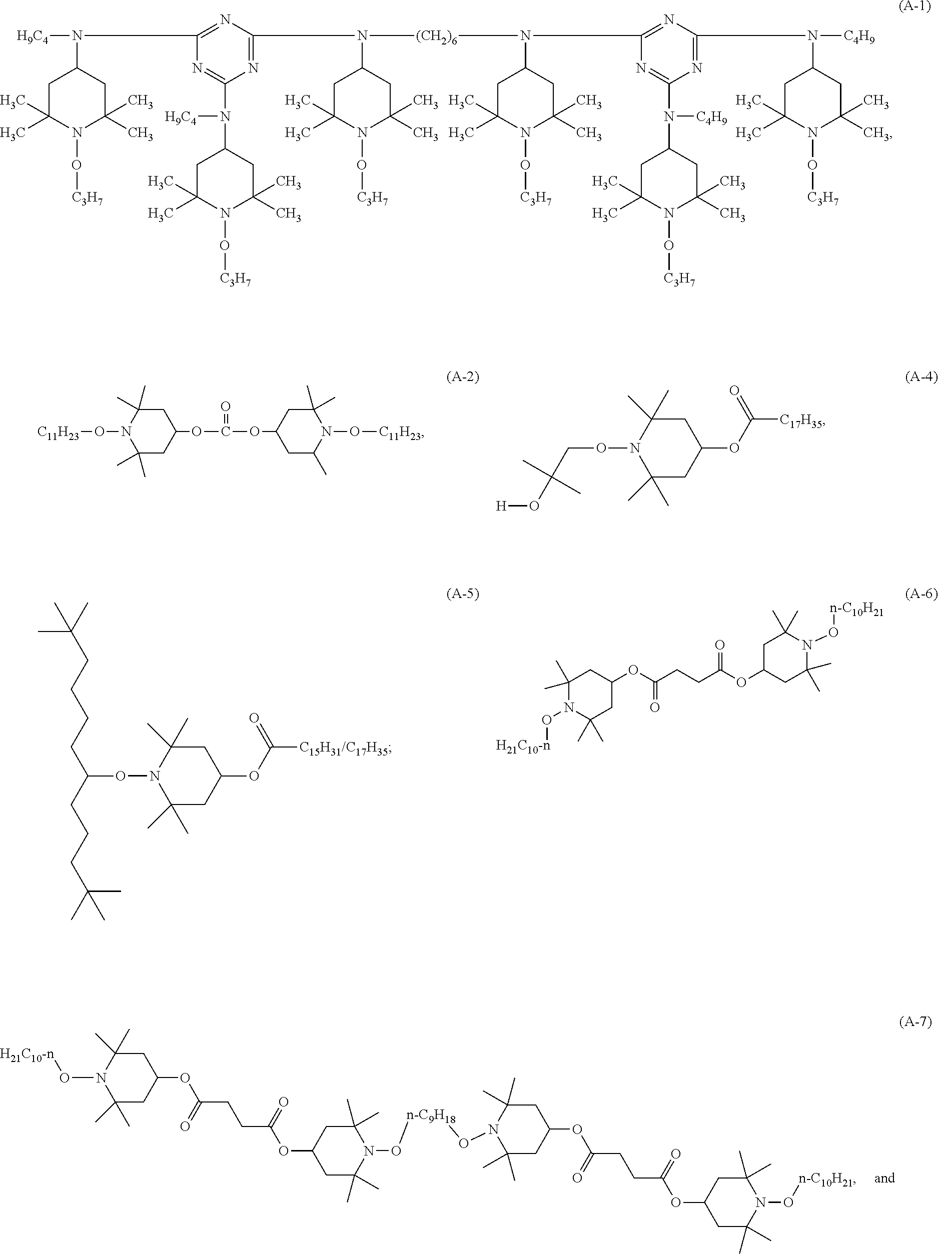

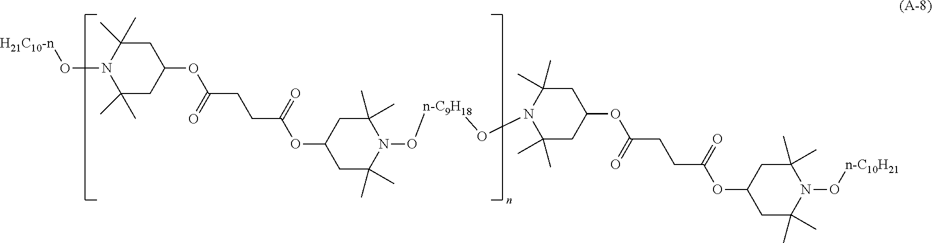

wherein n is 2,
(ii) at least one UV absorber; and
(iii) at least one metal hydroxide.
11. The method according to one or more of embodiments 1 to 9 or the stabilizer mixture according to embodiment 10, wherein the at least one UV absorber is selected from 2-(2′-hydroxyphenyl)benzotriazoles, 2-hydroxybenzophenones, 2-(2-hydroxyphenyl)-1,3,5-triazines and mixtures thereof.
12. The method according to one or more of embodiments 1 to 9 or the stabilizer mixture according to embodiments 10 or 11, wherein the 2-(2′-hydroxyphenyl)benzotriazole is selected from 2-(2H-benzotriazol-2-yl)-4,6-bis(1-methyl-1-phenylethyl)phenol, 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole,2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

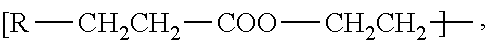

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; and 2-[2′-hydroxy-3′-(1,1,3,3-tetramethylbutyl)-5′-(α,α-dimethylbenzyl)-phenyl]benzotriazole, and mixtures thereof.
13. The method according to one or more of embodiments 1 to 9 or the stabilizer mixture according to one or more of embodiments 10 to 12, wherein the 2-hydroxybenzophenone is selected from 4-hydroxy, 4-methoxy, 4-octyloxy, 4-decyloxy, 4-dodecyloxy, 4-benzyloxy, 4,2′,4′-trihydroxy, 2′-hydroxy-4,4′-dimethoxy derivatives and mixtures thereof.
14. The method according to one or more of embodiments 1 to 9 or the stabilizer mixture according to one or more of embodiments 10 to 13, wherein the 2-(2-hydroxyphenyl)-1,3,5-triazine is selected from 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl¬oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-di¬methylphenyl)-1,3,5-triazine, 2,4-bis(4-[2-ethylhexyloxy]-2-hydroxyphenyl)6-(4-methoxyphenyl)-1,3,5-triazine, 2,4-bis(4-biphenylyl)-6-[2-hydroxy-4-(2-ethylhexyloxy)phenyl]-1,3,5-triazine, Dodecanedioic acid, 1,12-bis[2-[4-(4,6-diphenyl-1,3,5-triazin-2-yl)-3-hydroxyphenoxy]ethyl] ester and mixtures thereof.
15. The method according to one or more of embodiments 1 to 9 or the stabilizer mixture according to one or more of embodiments 10 to 14, wherein the at least one metal hydroxide is selected from hydrotalcite and magnesium hydroxide.
16. The method according to one or more of embodiments 1 to 9 or the stabilizer mixture according to one or more of claims 10 to 15, wherein the hydrotalcite is selected from magnesium aluminum hydroxide carbonate hydrate, and zinc aluminum hydroxide carbonate hydrate.
17. The method according to one or more of embodiments 1 to 9 or the stabilizer mixture according to one or more of embodiments 10 to 16, wherein the weight ratio of the at least one compound (A) to the at least one UV absorber is in the range of 1:1 to 20:1.
18. The method according to one or more of embodiments 1 to 9 or the stabilizer mixture according to one or more of embodiments 10 to 17, wherein the weight ratio of the at least one compound (A) to the at least one metal hydroxide is in the range of 1:10 to 10:1.
19. The method according to one or more of embodiments 1 to 9 or the stabilizer mixture according to one or more of embodiments 10 to 18, wherein the weight ratio of the at least one UV absorber to the at least one metal hydroxide is in the range of 10:1 to 1:20.
20. The method according to one or more of embodiments 1 to 9 or the stabilizer mixture according to one or more of embodiments 10 to 19, wherein the stabilizer mixture further comprises at least one light stabilizers.
21. The method according to one or more of embodiments 1 to 9 or the stabilizer mixture according to one or more of embodiments 10 to 20, wherein the light stabilizer is selected from bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; N-(2,2,6,6-tetramethyl-4-piperidyl)n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 5-(2-ethylhexanoyl)oxymethyl-3,3,5-trimethyl-2-morpholinone, Sanduvor, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, and mixtures thereof.
22. A composition comprising:
   I. an organic material, and
   II. a stabilizer mixture according to one or more of embodiments 10 to 21.
23. The composition according to embodiment 22, further comprising at least one additive selected from the antioxidants, slip agents, anti-block agents, thermal fillers, pigments, anti-fog and anti-mist agents.
24. The composition according to embodiments 22 or 23, wherein the weight ratio of the organic material to the stabilizer mixture is in the range of 0.005:10%.
25. An article comprising the composition according to one or more of embodiments 22 to 24.
26. The article according to embodiment 25, which is a monolayer film or a multilayer film of three to twelve layers.
27. The article according to embodiments 25 or 26, wherein the multilayer film contains at least one compound (A) as defined in embodiment 1 in at least one layer, and at least one compound of the UV absorber and a compound of the at least one metal hydroxide as defined in embodiment 1 independently in another layers.
28. The article according to one or more of embodiments 25 to 27, which is a greenhouse film cover, mulch film, artificial turfs, or geomembrane.
29. The article according to one or more of claim embodiments 25 to 28, wherein the green-house film cover, mulch film, artificial turf, or geomembrane is in contact with an agro-chemical compound or bleaching agent.
30. Use of the stabilizer mixture according to one or more of embodiments 10 to 21 for stabilizing an organic material by reducing degradation induced by a chlorine containing compound having the chlorine content in the range of 100 to 600 ppm.
31. The composition according to one or more of embodiments 22 to 24 or the use according to embodiment 30, wherein the organic material is selected from linear low-density polyethylene, low-density polyethylene, high density polyethylene, ethylene-vinyl acetate copolymer, ethylene-butyl acrylate copolymer, polypropylene homopolymer and polypropylene copolymer, preferably linear low-density polyethylene, low-density polyethylene, high density polyethylene, ethylene-vinyl acetate copolymer, and ethylene-butyl acrylate copolymer.
32. The use according to embodiments 30 or 31, wherein the chlorine containing compound is selected from an agrochemical compound, and a bleaching agent.

The following examples illustrate the invention in greater detail. All percentages and parts are by weight, unless stated otherwise.

### EXAMPLES

### Compounds

### Compound (A-2)

### Bis(1-undecanoxy-2,2,6,6-tetramethylpiperidin-4-yl)carbonate

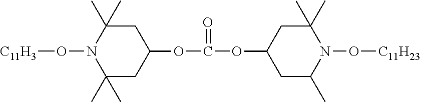

### Compound (A-3)

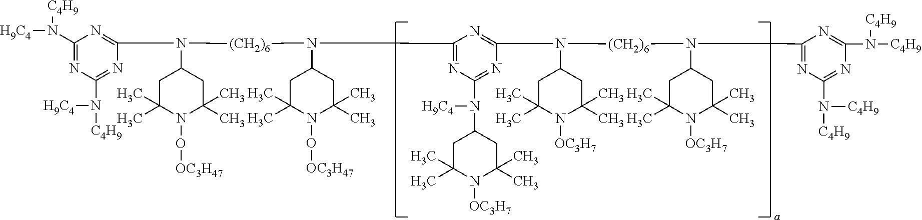

wherein a is an integer in the range of 1 to 10.

### Compound (A-4)

### 1-(2-hydroxy-2-methylpropoxy)-2,2,6,6-tetramethylpiperidine-4-yl octadecenoate

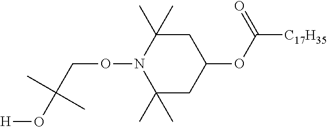

### Compound (B-1)

### 2-(2′-hydroxy-5′-(1,1,3,3-tetramethylbutyl)phenyl)benzotriazole

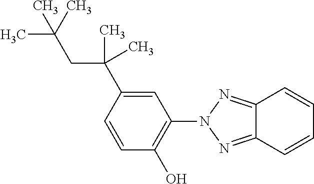 [SMILES: CC(C)(C)CC(C)(C)c1ccc(O)c(-n2nc3ccccc3n2)c1]

### Compound (B-2)

### 2,4-bis(4-biphenylyl)-6-[2-hydroxy-4-(2-ethylhexyloxy)phenyl]-1,3,5-triazine

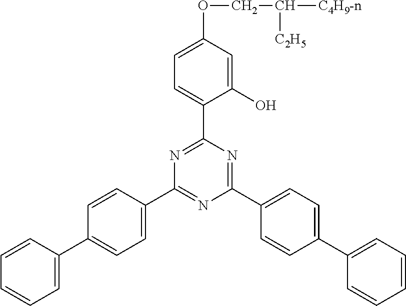

### Compound (B-3)

### Condensate of 1-(2-hydroxyethyl)-2,2,6,6-tetramethyl-4-hydroxypiperidine and succinic acid

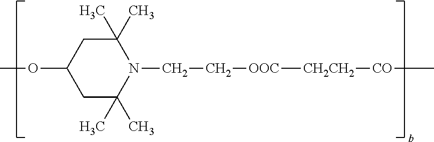

wherein b is a number from 2 to 10.

### Compound (C-1)

(CAS number: 012304-65-3 or 11097-59-9)

Hydrotalcite (Magnesium aluminum hydroxide carbonate hydrate)

### Compound (C-2)

Magnifin H-5 IV (is aminosilane surface treated)

(CAS number: 1309-42-8)

Magnesium hydroxide

### Compound (C-3)

Kisuma 10A

(CAS number: 1309-42-8)

Magnesium hydroxide

A) Preparation of the Film Samples:

Stabilization of LDPE (low density polyethylene) multi-layer films: Formulations containing LDPE powder (Polimeri Europa Riblene® FC 30, characterized by a density of 0.922 g/cm³ and a melt flow index (190° C./2.16 Kg) of 0.27 g/10 min), 0.04% by weight, relative to the weight of the LDPE, of tris{2,4-di-tert-butylphenyl} phosphite, 0.01% by weight, relative to the weight of the LDPE, of octadecyl 3-(3,5-di-tert-butyl-4-hydroxyphenyl)propionate and the stabilizer mixtures indicated in Tables 1 and 2, were prepared. The formulations were mixed in a turbo-mixer. Each formulation was extruded at a maximum temperature of 200° C. in a lab-scale single-screw Collin extruder (Ø 42 mm, L/D=25). Then, each final formulation was blown in a lab-scale Collin® 5-layer blow-extruder (Ø 20-25-30 mm, L/D 25), at a maximum temperature of 210° C., to give a 5-layer film having the same formulation in all layers. The overall thickness of the film was 160 μm (50 μm-15 μm-30 μm-15 μm-50 μm).

B) Test qmethod A

A bleach treatment was carried out on the prepared films before artificial weathering. Specimens of the films for each formulation were treated with sodium hypochlorite (NaClO)—H₂O 1:4 solution for 24 hours at t=0 hours. The chlorine determination was performed immediately after the treatment and at every recall (every 1000 hours exposure in artificial weathering) to determine the next treatment. The chlorine content was determined using oxidative pyrolysis and coulometry.

After the agrochemical treatment, the film specimens for each formulation were exposed in an Atlas Weather-O-Meter (WOM, as per ASTM G155, 0.35 W/m2 at 340 nm, dry cycle), for accelerated light weathering. Specimens of the film samples were taken at defined intervals of time after exposure and underwent tensile testing. The residual tensile strength was measured, by means of a Zwick® Z1.0 constant velocity tensiometer (as per modified ISO 527), in order to evaluate the decay of the mechanical properties of the film samples, as a consequence of the polymer degradation after its oxidation.

The test results are listed in Tables 1 and 2.

TABLE 1
NOR HALS [Compound of (A-3)] and UV Package with and
without Hydrotalcite Film samples contaminated with 400-
500 ppm chlorine after each treatment and exposed in a WOM.

| | | Time until retained |
|---|---|---|
| | Stabilizer mixture | elongation at break |
| | (weight-% based on | in hours is 50% of |
| | polymer composition) | the initial value |
| Example 1 | 0.55% of Compound (A-3) | 3489 |
| (Comparative) | 0.049% of Compound (B-1) | |
| | 0.015% of Compound (B-2) | |
| Example 2 | 0.55% of Compound (A-3) | 3724 |
| | 0.049% of Compound (B-1) | |
| | 0.015% of Compound (B-2) | |
| | 0.3% of Compound (C-1) | |
| Example 3 | 0.55% of Compound (A-3) | 3713 |
| | 0.049% of Compound (B-1) | |
| | 0.015% of Compound (B-2) | |
| | 0.6% of Compound (C-1) | |
| Example 4 | 0.55% of Compound (A-3) | 3831 |
| | 0.049% of Compound (B-1) | |
| | 0.015% of Compound (B-2) | |
| | 0.6% of Compound (C-2) | |
| Example 5 | 0.55% of Compound (A-3) | 3857 |
| | 0.049% of Compound (B-1) | |
| | 0.015% of Compound (B-2) | |
| | 0.6% of Compound (C-3) | |
| Example 6 | 0.55% of Compound (A-3) | 3827 |
| | 0.049% of Compound (B-1) | |
| | 0.015% of Compound (B-2) | |
| | 0.3% of Compound (C-1) | |
| | 0.3% of Compound (C-2) | |
| Example 7 | 0.55% of Compound (A-3) | 3655 |
| | 0.049% of Compound (B-1) | |
| | 0.015% of Compound (B-2) | |
| | 0.3% of Compound (C-1) | |
| | 0.3% of Compound (C-3) | |

Example 1: Comparative example, and Examples 2 to 7: According to the present invention

TABLE 2
HALS [Compounds of formula (B-1), (B-2), and (B-3)]
combination including NOR HALS and UV Package with and
without Hydrotalcite Film samples contaminated with 400-
500 ppm chlorine after each treatment and exposed in a WOM.

| | | Time until retained |
|---|---|---|
| | Stabilizer mixture | elongation at break |
| | (weight-% based on | in hours is 50% of |
| | polymer composition) | the initial value |
| Example 8 | 0.4% of Compound (A-3) | 3626 |
| (Comparative) | 0.049% of Compound (B-1) | |
| | 0.015% of Compound (B-2) | |
| | 0.1% of Compound (B-3) | |
| | 0.1% of Compound (A-4) | |
| Example 9 | 0.4% of Compound (A-3) | 4048 |
| | 0.1% of Compound (B-3) | |
| | 0.1% of Compound (A-4) | |
| | 0.049% of Compound (B-1) | |
| | 0.015% of Compound (B-2) | |
| | 0.3% of Compound (C-1) | |
| | 0.3% of Compound (C-2) | |

Example 8: Comparative example, and Example 9: According to the present invention

The results shown in the Tables 1 and 2 clearly show that the additional use of Hydrotalcite in a low amount results in a substantial improvement of the elongation at break property of the film prepared in accordance of the present invention, when the film is exposed to a high level of chlorine.

1. A method for stabilizing an organic material by reducing degradation induced by a chlorine containing compound having a chlorine content in the range of 100 to 600 ppm, wherein the method comprises incorporating into the organic material a stabilizer mixture comprising:
(i) at least one compound (A) selected from general formula (I), general formula (II), general formula (III), general formula (IV), and mixtures thereof,
compound (A) of general formula (I) 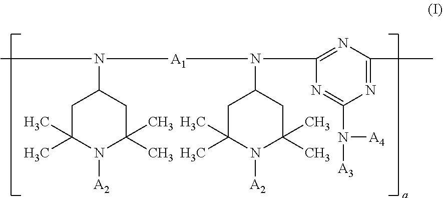
wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 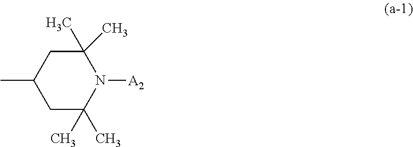
or
A₃ and A₄, together with the nitrogen atom to which they are bonded, form a 5- to 10-membered heterocyclic ring, and
a is an integer in the range of 1 to 20 and the repeating units are the same or different,
compound (A) of general formula (II) 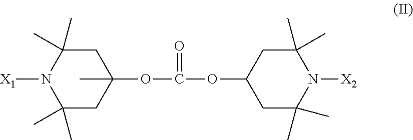
wherein
x₁ and x₂ are independently selected from linear or branched, substituted or unsubstituted C₁ to C₃₀ alkyloxy,
compound (A) of general formula (III) 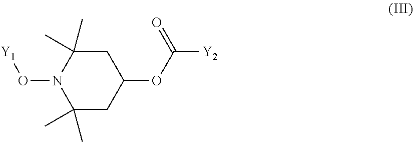
wherein
Y₁ is linear or branched, substituted or unsubstituted C₃ to C₂₀ alkyl,
Y₂ is linear or branched, substituted or unsubstituted C₁ to C₃₀ alkyl; and
compound (A) of general formula (IV) 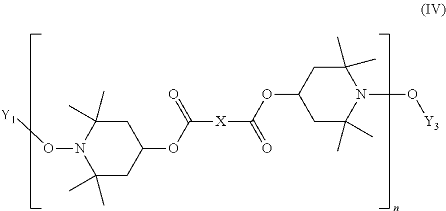
wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber; and
(iii) at least one metal hydroxide.

2. The method according to claim 1, wherein the organic material is selected from linear low-density polyethylene, low-density polyethylene, high density polyethylene, ethylene-vinyl acetate copolymer, ethylene-butyl acrylate copolymer, polypropylene homopolymer or polypropylene copolymer.

3. The method according to claim 1, wherein the stabilizer mixture comprises:
(i) at least one compound (A) selected from general formula (I), general formula (II), general formula (III), general formula (IV), and mixtures thereof
compound (A) of general formula (I) 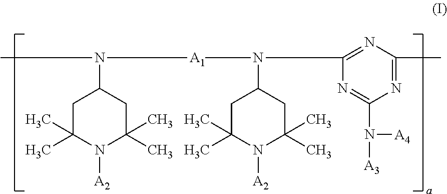
wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from linear or branched, substituted or unsubstituted C₁-C₁₂ alkyloxy, and substituted or unsubstituted C₅-C₁₂ cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 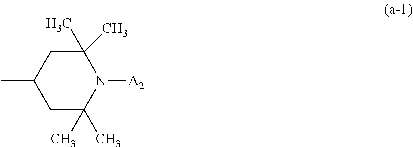
or
A₃ and A₄, together with the nitrogen atom to which they are bonded, form a 5- to 10-membered heterocyclic ring, and
a is an integer in the range of 1 to 20 and the repeating units are the same or different,
compound (A) of general formula (II) 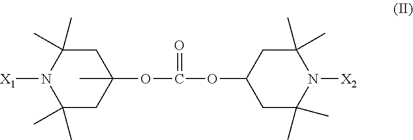
wherein
x₁ and x₂ is independently selected from linear or branched, substituted or unsubstituted C₁ to C₃₀ alkyloxy,
compound (A) of general formula (III) 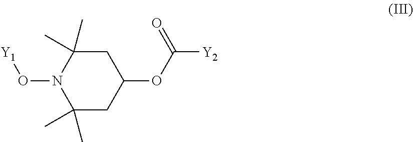
wherein
Y₁ is linear or branched, substituted or unsubstituted linear or branched, substituted or unsubstituted C₃ to C₂₀ alkyl,
Y₂ is linear or branched, substituted or unsubstituted C₁ to C₃₀ alkyl; and
compound (A) of general formula (IV) 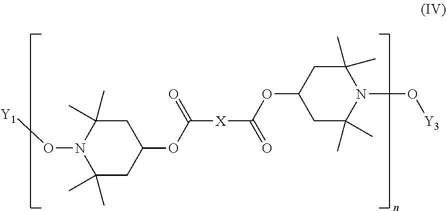
wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber, and
(iii) at least one metal hydroxide.

4. The method according to claim 1, wherein the stabilizer mixture comprises:
(i) at least one compound (A) selected from general formula (I), general formula (II), general formula (III), general formula (IV), and mixtures thereof,
compound (A) of general formula (I) 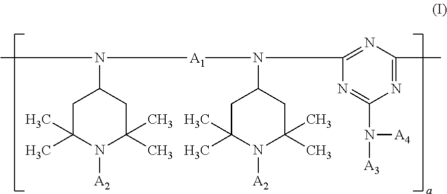
wherein
A₁ is selected from linear or branched, substituted or unsubstituted C₂-C₁₈ alkylene, substituted or unsubstituted C₅-C₇ cycloalkylene, and C₁-C₄alkylenedi(C₅-C₇ cyclo alkylene),
A₂ is independently selected from H, linear or branched, substituted or unsubstituted C₁-C₁₂ alkyl, and substituted or unsubstituted C₅-C₁₂ cycloalkyl,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 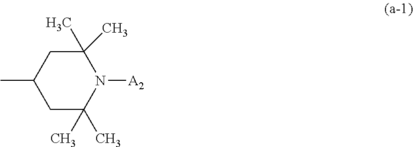
or A₃ and A₄, together with the nitrogen atom to which they are bonded, form a 5- to 10-membered heterocyclic ring; and
a is an integer in the range of 1 to 20 and the repeating units are the same or different,
compound (A) of general formula (II) 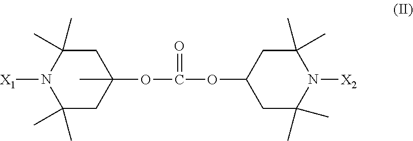
wherein
x₁ and x₂ are independently selected from linear or branched, substituted or unsubstituted C₁ to C₃₀ alkyloxy,
compound (A) of general formula (III) 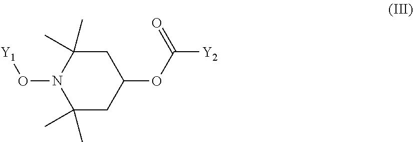
wherein
Y₁ is linear or branched, substituted or unsubstituted C₃ to C₂₀ alkyl,
Y₂ is linear or branched, substituted or unsubstituted C₁ to C₃₀ alkyl; and
compound (A) of general formula (IV) 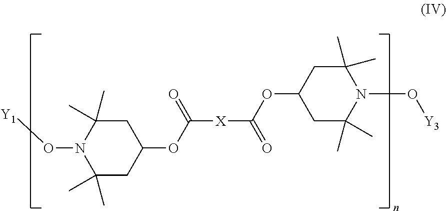
wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is linear or branched, substituted or unsubstituted C₂ to C₅ alkyl,
n is an integer in the range of 1 to 8, and
(ii) at least one UV absorber; and
(iii) at least one metal hydroxide.

5. The method according to claim 1, wherein the compound (A) is at least one compound selected from the formula (A-1), (A-2), (A-3), (A-4), (A-5), (A-6), (A-7), and/or (A-8) 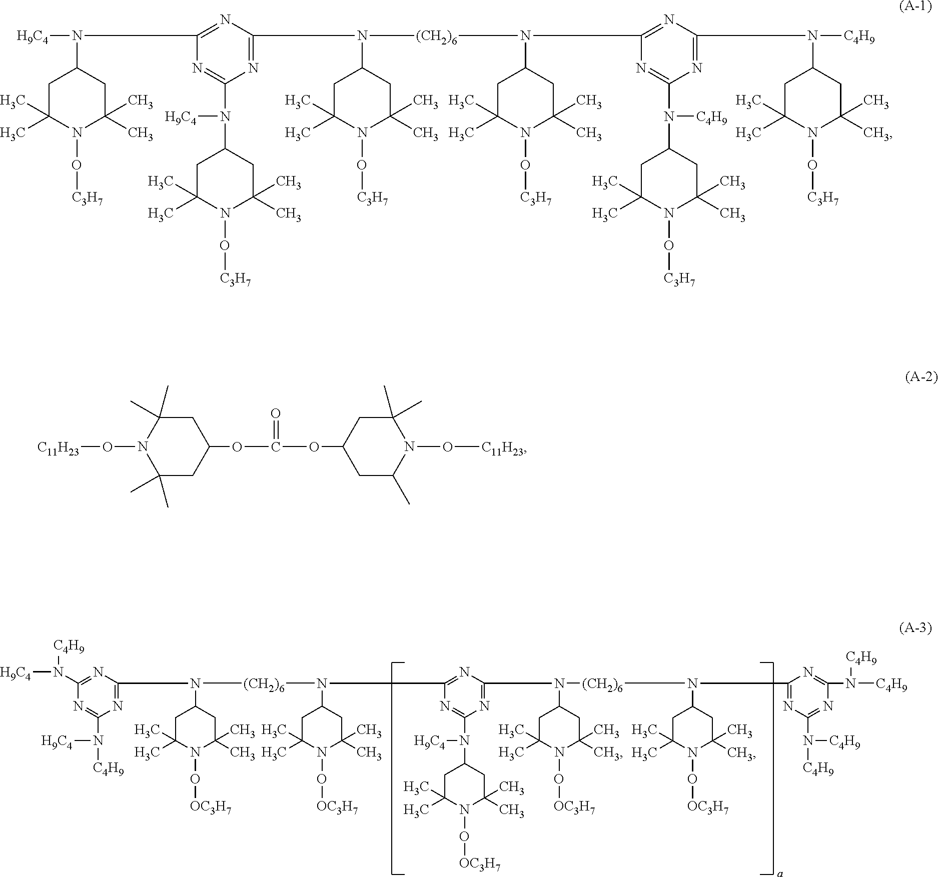
wherein a is an integer in the range of 1 to 10, 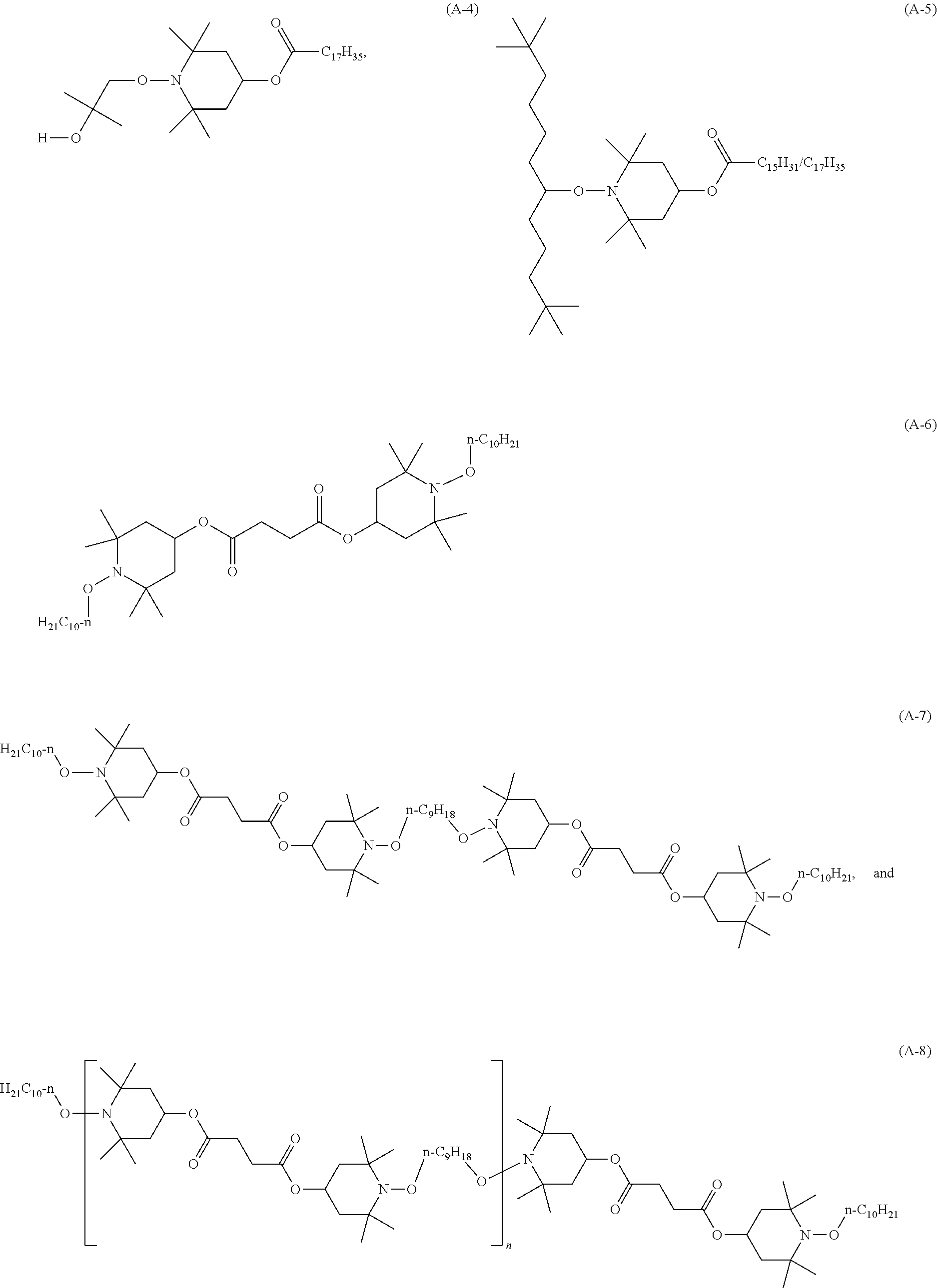
wherein n is 2.

6. The method according to claim 1, wherein the compound (A) is a compound of formula (A-9) 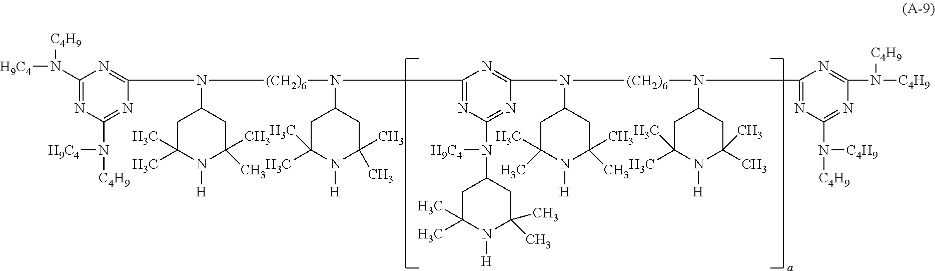
wherein a is an integer in the range of 1 to 10.

7. A stabilizer mixture comprising:
(i) at least one compound (A) selected from the general formula (A-1), general formula (A-2), general formula (A-4), general formula (A-5), general formula (A-6), general formula (A-7), and/or general formula (A-8) 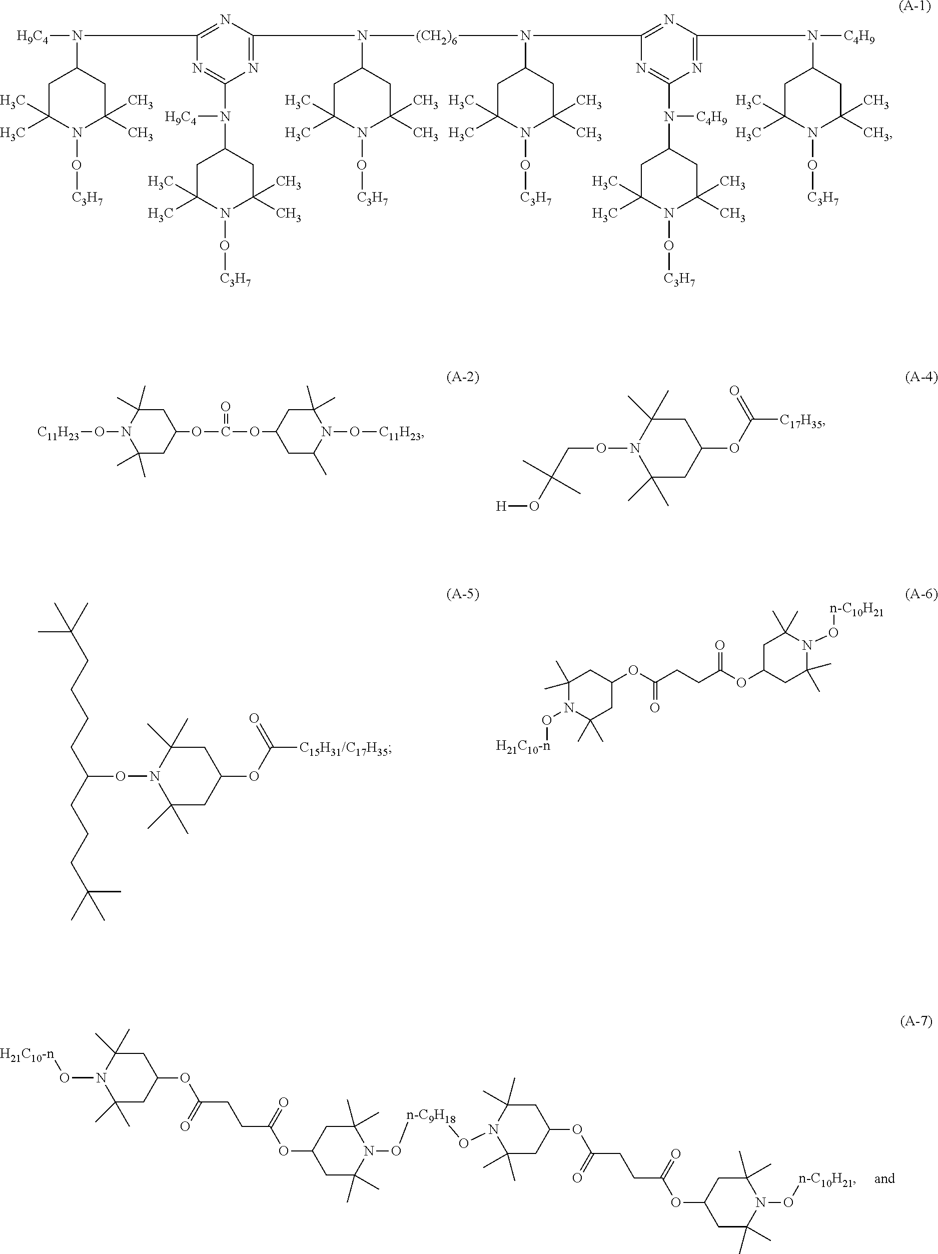 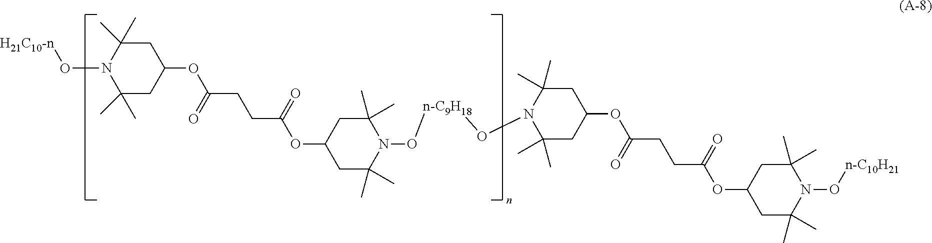
wherein n is 2,
(ii) at least one UV absorber; and
(iii) at least one metal hydroxide.

8. The method according to claim 1, wherein the at least one UV absorber is selected from 2-(2′-hydroxyphenyl)benzotriazoles, 2-hydroxybenzophenones, 2-(2-hydroxyphenyl)-1,3,5-triazines and mixtures thereof.

9. The method according to claim 1, wherein the at least one metal hydroxide is selected from hydrotalcite or magnesium hydroxide.

10. The method according to claim 1, wherein the hydrotalcite is selected from magnesium aluminum hydroxide carbonate hydrate, or zinc aluminum hydroxide carbonate hydrate.

11. The method according to claim 1, wherein the weight ratio of the at least one compound (A) to the at least one UV absorber is in the range of 1:1 to 20:1, the weight ratio of the at least one compound (A) to the at least one metal hydroxide is in the range of 1:10 to 10:1, and the weight ratio of the at least one UV absorber to the at least one metal hydroxide is in the range of 10:1 to 1:20.

12. The method according to claim 1, wherein the stabilizer mixture further comprises at least one light stabilizers.

13. A composition comprising:
I. an organic material, and
II. a stabilizer mixture according to claim 7.

14. The composition according to claim 13, further comprising at least one additive selected from the antioxidants, slip agents, anti-block agents, thermal fillers, pigments, anti-fog and/or anti-mist agents.

15. The composition according to claim 13, wherein the weight ratio of the organic material to the stabilizer mixture is in the range of 0.005:10%.

16. An article comprising the composition according to claim 13.

17. The article according to claim 16, which is a monolayer film or a multilayer film of three to twelve layers, wherein the multilayer film contains at least one compound (A) in at least one layer, and at least one compound of the UV absorber and a compound of the at least one metal hydroxide in another layers.

18. The article according to claim 16, which is a greenhouse film cover, mulch film, artificial turfs, or geomembrane.

19. (canceled)

20. The stabilizer mixture according to claim 7,
wherein the at least one UV absorber is selected from 2-(2′-hydroxyphenyl)benzotriazoles, 2-hydroxybenzophenones, 2-(2-hydroxyphenyl)-1,3,5-triazines and mixtures thereof,
wherein the at least one metal hydroxide is selected from hydrotalcite or magnesium hydroxide,
wherein the hydrotalcite is selected from magnesium aluminum hydroxide carbonate hydrate, or zinc aluminum hydroxide carbonate hydrate,
wherein the weight ratio of the at least one compound (A) to the at least one UV absorber is in the range of 1:1 to 20:1, the weight ratio of the at least one compound (A) to the at least one metal hydroxide is in the range of 1:10 to 10:1, and the weight ratio of the at least one UV absorber to the at least one metal hydroxide is in the range of 10:1 to 1:20, or
wherein the stabilizer mixture further comprises at least one light stabilizers.
